(19) United States
(12) Patent Application Publication
(10) Pub. No.: US 2026/0031877 A1
(43) Pub. Date: Jan. 29, 2026

(54) METHOD AND APPARATUS FOR CONFIGURING CHANNEL STATE INFORMATION

(71) Applicant: FUJITSU LIMITED, Kawasaki-shi (JP)

(72) Inventors: Yiwen LU, Beijing (CN); Jing ZHU, Beijing (CN); Jian ZHANG, Beijing (CN); Lei ZHANG, Beijing (CN)

(73) Assignee: FUJITSU LIMITED, Kawasaki-shi (JP)

(21) Appl. No.: 19/345,215

(22) Filed: Sep. 30, 2025

Related U.S. Application Data
(63) Continuation of application No. PCT/CN2023/087130, filed on Apr. 7, 2023.

(51) Int. Cl. H04B 7/06; H04W 72/044

(52) U.S. Cl. CPC H04B 7/0626; H04W 72/044

(57) ABSTRACT

An apparatus for configuring channel state information, configured in a terminal equipment, includes: a receiver configured to receive a first resource configuration and/or a second resource configuration and/or a CSI report configuration, the first resource configuration being at least used to configure first resources of M ports, the first resource configuration and/or the second resource configuration and/or the CSI report configuration being used to configure second resources of N ports, N being less than M.

### CROSS-REFERENCE TO RELATED APPLICATION

This application is a continuation application under 35 U.S.C. 111(a) of International Patent Application PCT/CN2023/087130 filed on Apr. 7, 2023, and designated the U.S., the entire contents of which are incorporated herein by reference.

### FIELD

Embodiments of the present disclosure relate to the technical field of communications.

### BACKGROUND

With the popularization of 5G (fifth-generation mobile communication system) in various industries and its application in more geographical regions, in order to handle more advanced services, very high data rates and denser networks are required, more antennas, greater bandwidths and more frequency bands are used, thereby energy consumption of a 5G device is getting greater and greater.

According to data statistics from operators, average energy consumption of a 5G base station is more than three times that of an LTE (3GPP (Third Generation Partnership Program) Long Term Evolution) base station, and nearly 50% of the cost for deploying a 5G network by operators is electricity fee overhead. More importantly, even during periods when there is no service, the energy consumption cost of the 5G base station is still very high. Thus, network energy saving has important significance for enhancing sustainability of the environment, reducing impacts (for example reducing greenhouse gas emission) on the environment and saving operating costs, 5G network energy saving is an urgent problem to be solved.

In order to achieve network energy saving, Rel-18 (version 18) initiated topics related to network energy saving to study various energy saving technologies. In the discussion, network energy saving technologies may be classified into types such as time-domain/frequency-domain/spatial-domain/energy-domain energy saving. Spatial-domain energy saving for example is dynamical adjusting the number of antennas, energy-domain energy saving for example is dynamical adjusting data transmission power, and time-domain energy saving for example is introducing a cell DTX/DRX (non-continuous transmission/reception) technologies, and so on. Using various energy saving technologies can save a large amount of energy for a network device and/or a terminal equipment.

It should be noted that the above introduction to the technical background is just to facilitate a clear and complete description of the technical solutions of the present disclosure, and is elaborated to facilitate understanding of persons skilled in the art. It cannot be considered that these technical solutions are known by persons skilled in the art just because these solutions are elaborated in the Background of the present disclosure.

### SUMMARY

However, the inventor finds that the above-mentioned energy saving technologies may have negative impacts on other processes or technologies in a communication system. For example, when a network device dynamically adjusts the number of antennas, it may cause a change in a channel, resulting in an inaccurate or untimely measurement result of Channel State Information (CSI) from a terminal equipment or an inaccurate or untimely CSI report result thereof, ultimately affecting the transmission performance. Therefore, when the network device adjusts an antenna configuration (for example, for the purpose of energy saving), how to enable the terminal device to perform CSI measurement efficiently and accurately has become an urgent problem to be solved in network energy saving technologies.

For at least one of the above problems, the embodiments of the present disclosure provide a method and an apparatus for configuring channel state information.

According to an aspect of the embodiments of the present disclosure, an apparatus for configuring channel state information, configured in a terminal equipment, wherein the apparatus comprises:
a receiving unit configured to receive a first resource configuration and/or a second resource configuration and/or a CSI report configuration,
the first resource configuration being at least used to configure first resources of M ports,
the first resource configuration and/or the second resource configuration and/or the CSI report configuration being used to configure second resources of N ports,
N being less than M.

According to another aspect of the embodiments of the present disclosure, an apparatus for configuring channel state information, configured in a network device, wherein the apparatus comprises:
a transmitting unit configured to transmit a first resource configuration and/or a second resource configuration and/or a CSI report configuration,
the first resource configuration being at least used to configure first resources of M ports,
the first resource configuration and/or the second resource configuration and/or the CSI report configuration being used to configure second resources of N ports,
N being less than M.

According to a further aspect of the embodiments of the present disclosure, a communication system is provided, comprising:
a network device configured to transmit a first resource configuration and/or a second resource configuration and/or a CSI report configuration, and
a terminal equipment configured to receive the first resource configuration and/or the second resource configuration and/or the CSI report configuration,
wherein,
the first resource configuration being at least used to configure first resources of M ports,
the first resource configuration and/or the second resource configuration and/or the CSI report configuration being used to configure second resources of N ports,
N being less than M.

One of advantageous effects of the embodiments of the present disclosure lies in: according to the embodiments of the present disclosure, when a network device adjusts an antenna configuration, by adding restrictions on indication of some antenna ports/patterns, current CSI report is capable of more dynamically matching an actually deployed antenna adjustment.

Thereby, a terminal equipment is capable of performing CSI measurement efficiently and accurately, so as to provide accurate channel information for the scheduling of the network device.

Referring to the later description and drawings, specific implementations of the present disclosure are disclosed in detail, indicating a mode that the principle of the present disclosure may be adopted. It should be understood that the implementations of the present disclosure are not limited in terms of a scope. Within the scope of the spirit and terms of the attached claims, the implementations of the present disclosure include many changes, modifications and equivalents.

Features that are described and/or shown for one implementation may be used in the same way or in a similar way in one or more other implementations, may be combined with or replace features in the other implementations.

It should be emphasized that the term “comprise/include” when being used herein refers to presence of a feature, a whole piece, a step or a component, but does not exclude presence or addition of one or more other features, whole pieces, steps or components.

### BRIEF DESCRIPTION OF THE DRAWINGS

An element and a feature described in a drawing or an implementation of the embodiments of the present disclosure may be combined with an element and a feature shown in one or more other drawings or implementations. In addition, in the drawings, similar labels represent corresponding components in several drawings and may be used to indicate corresponding components used in more than one implementation.

FIG. 1 is a schematic diagram of a communication system in the embodiments of the present disclosure;

FIG. 2 is a schematic diagram of a CDM pattern in the embodiments of the present disclosure;

FIG. 3 is a schematic diagram of port multiplexing in the embodiments of the present disclosure;

FIG. 4 is another schematic diagram of port multiplexing in the embodiments of the present disclosure;

FIG. 5 is a schematic diagram of an antenna mode (array);

FIG. 6 is a schematic diagram of three antenna configurations;

FIG. 7 is a schematic diagram of port mapping under an antenna OFF pattern;

FIG. 8 is a schematic diagram of a method for configuring channel state information in the embodiments of the present disclosure;

FIG. 9 is a schematic diagram of a first resource of 24 ports;

FIG. 10 is a schematic diagram of a 24-port antenna array;

FIG. 11 is a schematic diagram of a 4-port antenna array;

FIG. 12 is another schematic diagram of a 4-port antenna array;

FIG. 13 is a schematic diagram of an 8-port antenna array;

FIG. 14 is a schematic diagram of a 12-port antenna array;

FIG. 15 is a schematic diagram of a 16-port antenna array;

FIG. 16 is a schematic diagram of a 24-port antenna array;

FIG. 17 is another schematic diagram of a 24-port antenna array;

FIG. 18 is a schematic diagram of a 32-port antenna array;

FIG. 19 is another schematic diagram of a 32-port antenna array;

FIG. 20 is a schematic diagram of selecting a second resource of 4 ports from the first resource of 24 ports;

FIG. 21 is a schematic diagram of a method for configuring channel state information in the embodiments of the present disclosure;

FIG. 22 is a schematic diagram of an apparatus for configuring channel state information in the embodiments of the present disclosure;

FIG. 23 is another schematic diagram of an apparatus for configuring channel state information in the embodiments of the present disclosure;

FIG. 24 is a schematic diagram of a network device in the embodiments of the present disclosure;

FIG. 25 is a schematic diagram of a terminal equipment in the embodiments of the present disclosure.

### DETAILED DESCRIPTION

Referring to the drawings, via the following Specification, the aforementioned and other features of the present disclosure will become obvious. The Specification and the drawings specifically disclose particular implementations of the present disclosure, showing partial implementations which may adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as Long Term Evolution (LTE), LTE-Advanced (LTE-A), Wideband Code Division Multiple Access (WCDMA), High-Speed Packet Access (HSPA) and so on.

And, communication between devices in a communication system may be carried out according to a communication protocol at any stage, for example may include but be not limited to the following communication protocols: 1G (generation), 2G, 2.5G, 2.75G, 3G, 4G, 4.5G, and 5G, New Radio (NR), future 6G and so on, and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: a Base Station (BS), an Access Point (AP), a Transmission Reception Point (TRP), a broadcast transmitter, a Mobile Management Entity (MME), a gateway, a server, a Radio Network Controller (RNC), a Base Station Controller (BSC) and so on.

The base station may include but be not limited to: a node B (NodeB or NB), an evolution node B (eNodeB or eNB), a 5G base station (gNB) and an IAB donor, etc., and may further includes a Remote Radio Head (RRH), a Remote Radio Unit (RRU), a relay or a low power node (such as femeto, pico, etc.). And the term “base station” may include some or all functions of a base station, each base station may provide communication coverage to a specific geographic region. The term “cell” may refer to a base station and/or its coverage area, which depends on the context in which this term is used.

In the embodiments of the present disclosure, the term “User Equipment (UE)” or “Terminal Equipment (TE) or Terminal Device” refers to, for example, a device that accesses a communication network and receives network services via a network device. The terminal equipment may be fixed or mobile, and may also be referred to as Mobile Station (MS), a terminal, Subscriber Station (SS), Access Terminal (AT) and a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera and so on.

For another example, under a scenario such as Internet of Things (IoT), the terminal equipment may also be a machine or apparatus for monitoring or measurement, for example may include but be not limited to: a Machine Type Communication (MTC) terminal, a vehicle-mounted communication terminal, a Device to Device (D2D) terminal, a Machine to Machine (M2M) terminal and so on.

Moreover, the term “a network side” or “a network device side” refers to a side of a network, may be a base station, and may include one or more network devices as described above. The term “a user side” or “a terminal side” or “a terminal equipment side” refers to a side of a user or terminal, may be a UE, and may include one or more terminal equipments as described above. If it is not specifically mentioned herein, “a device” may refer to a network device, or may refer to a terminal equipment.

Scenarios of the embodiments of the present disclosure are described via the following examples, however the present disclosure is not limited to these.

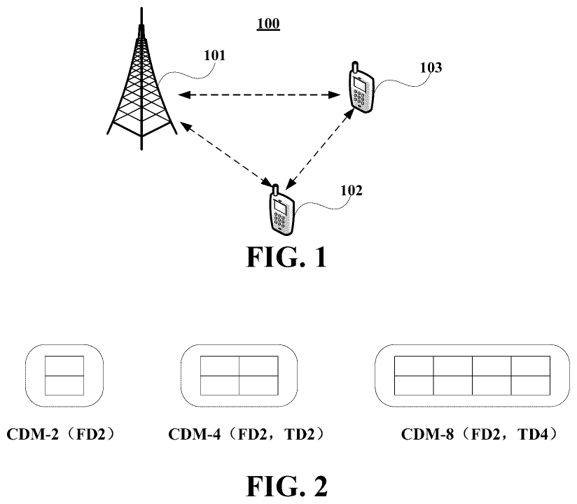

FIG. 1 is a schematic diagram of a communication system in the embodiments of the present disclosure, schematically describes situations by taking a terminal equipment and a network device as examples, as shown in FIG. 1, a communication system 100 may include a network device 101 and terminal equipments 102, 103. For simplicity, FIG. 1 only takes two terminal equipments and one network device as examples for description, however the embodiments of the present disclosure are not limited to this.

In the embodiments of the present disclosure, transmission of existing or further implementable services may be carried out between the network device 101 and the terminal equipments 102, 103. For example, these services may include but be not limited to: enhanced Mobile Broadband (eMBB), massive Machine Type Communication (mMTC), Ultra-Reliable and Low-Latency Communication (URLLC) and so on.

It is worth noting that FIG. 1 shows that two terminal equipments 102 and 103 are within the coverage of network device 101, but the present disclosure is not limited to this. The two terminal equipments 102 and 103 may be outside the coverage of the network device 101, or one terminal equipment 102 may be within the coverage of the network device 101 and the other terminal equipment 103 may be outside the coverage of the network device 101.

In the embodiments of the present disclosure, higher layer signaling may be e.g. radio resource control (RRC) signaling; for example, is called an RRC message, for example includes an MIB, system information, and a dedicated RRC message; or is called an RRC information element (RRC IE). The higher layer signaling, for example, may further be Medium Access Control (MAC) signaling; or called a MAC control element (MAC CE). However, the present disclosure is not limited to this.

In a mobile communication system, generally a terminal equipment performs CSI measurement according to indication and configuration of a network device, and then reports CSI obtained by measurement to the network device. When the network device schedules the terminal equipment, it may refer to this CSI so as to adopt an appropriate transmission mode on an appropriate physical resource to schedule the terminal equipment to perform transmission. Different terminal equipments may experience different physical channel conditions. Adopting a CSI feedback mechanism may rationally and effectively utilize physical resources, thereby improving the efficiency of entire network transmission.

In the CSI feedback mechanism of NR, the terminal equipment mainly measures a reference signal from the network device based on a CSI configuration and reports measurement result, the reference signal includes a channel state information reference signal (CSI-RS), and a synchronization signal block (SSB), etc. The CSI configuration of NR mainly includes: a resource configuration for CSI measurement, configured by the network device for the terminal equipment (which may be called a CSI-RS resource configuration), and a report configuration of how the terminal equipment performs report, configured by the network device (which may be called a CSI report configuration).

For example, the CSI-RS resource configuration mainly configures: time-frequency-spatial resources of CSI-RS resources, and necessary parameters for generating an RS sequence. In short, the terminal equipment is capable of accurately knowing an RS sequence transmitted by the network device and a specific time-frequency-spatial resource position of the sequence according to the CSI-RS resource configuration, so as to receive the sequence at a corresponding position and perform signal processing on a received sequence by taking the locally generated sequence as a reference to accurately estimate a channel. For how to specifically generate the RS sequence, relevant techniques may be referred to, detailed description is not provided here. Embodiments of the present disclosure will describe the CSI-RS resource configuration.

For a time-frequency position of each CSI-RS resource, the network device determines it via the following parameters in CSI-RS-ResourceMapping, as shown in Table 1 below.

TABLE 1

| | |
|---|---|
| CSI-RS-ResourceMapping ::= | SEQUENCE { |
| frequencyDomainAllocation | CHOICE { |
| row1 | BIT STRING (SIZE (4)), |
| row2 | BIT STRING (SIZE (12)), |
| row4 | BIT STRING (SIZE (3)), |
| other | BIT STRING (SIZE (6)) |

},

| | |
|---|---|
| nrofPorts | ENUMERATED |

{p1,p2,p4,p8,p12,p16,p24,p32},

| | |
|---|---|
| firstOFDMSymbolInTimeDomain | INTEGER (0..13), |
| firstOFDMSymbolInTimeDomain2 | INTEGER (2..12) |

OPTIONAL, -- Need R

| | |
|---|---|
| cdm-Type | ENUMERATED {noCDM, fd-CDM2, cdm4-FD2-TD2, |

cdm8-FD2-TD4},

| | |
|---|---|
| density | CHOICE { |
| dot5 | ENUMERATED {evenPRBs, oddPRBs}, |
| one | NULL, |
| three | NULL, |
| spare | NULL |

},

| | |
|---|---|
| freqBand | CSI-FrequencyOccupation, |

...
}

As shown in Table 1, firstOFDMSymbolInTimeDomain and firstOFDMSymbolInTimeDomain2 are used to determine positions of a CSI-RS resource in a time domain, NR currently supports occupation of 1, 2 or 4 Orthogonal Frequency Division Multiplexing (OFDM) symbols. Parameter frequencyDomainAllocation is used to determine a position of a CSI-RS resource in a frequency domain; parameter nrofports is used to determine the number of CSI-RS ports, NR currently supports configurations of 1, 2, 4, 8, 12, 16, 24 and 32 ports. Parameter cdm-Type is used to determine a type of Code Division Multiplexing (CDM) of the CSI-RS resource, NR currently supports three patterns i.e., CDM-2, CDM-4 and CDM-8.

FIG. 2 is a schematic diagram of a CDM pattern in the embodiments of the present disclosure. By taking CDM-4 as an example, this pattern includes 4 ports, each port occupies all resource elements (REs) in the pattern, and different orthogonal covering codes are adopted to distinguish between ports.

REs occupied by one CDM pattern constitute a CDM group, and each CDM group contains 2, 4 or 8 ports. In this way, a plurality of ports of a CSI-RS may be distributed into a plurality of CDM groups with the same pattern, that is, port distribution of the CSI-RS may be determined via CDM group aggregation.

NR supports multiple flexible aggregation schemes, and for the same port number configuration, supports multiple CDM aggregation schemes. NR flexibly supports a CSI-RS of 2 to 32 ports by using CDM group aggregation of these three CDM patterns i.e., CDM-2, CDM-4 and CDM-8. For a multi-port CSI-RS resource, multiple multiplexing modes may be adopted between different ports.

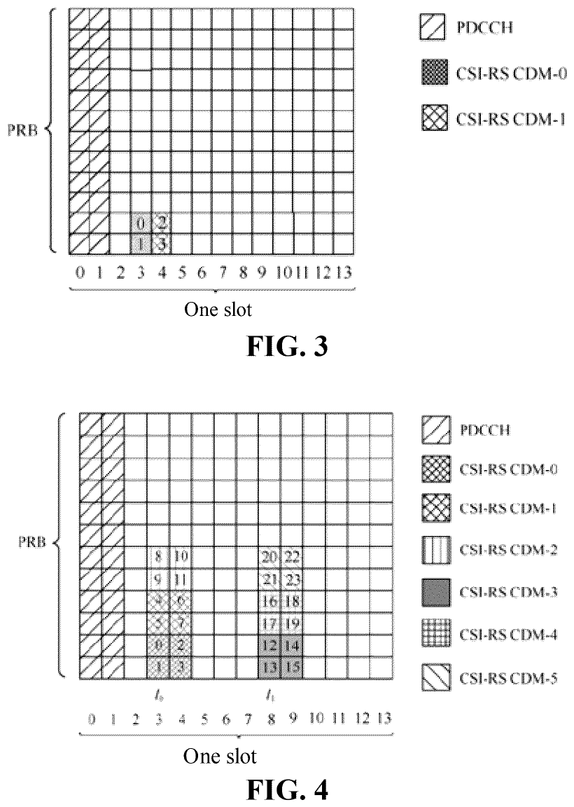

FIG. 3 is a schematic diagram of port multiplexing in the embodiments of the present disclosure. As shown in FIG. 3, a CDM+TDM mode is used, a 4-port CSI-RS resource is aggregated using the CDM-2 pattern, divided into two CDM groups, each CSI-RS port in the CDM group is mapped onto 2 REs in this pattern, and orthogonal multiplexing is achieved between ports based on an orthogonal covering code (OCC) with a length being 2. Ports (such as ports 0, 1 and 2, 3) between CDM groups achieve orthogonality via TDM.

FIG. 4 is another schematic diagram of port multiplexing in the embodiments of the present disclosure. As shown in FIG. 4, a CDM+FDM+TDM mode is used, a 24-port CSI-RS resource is aggregated using the CDM-4 pattern, divided into 6 CDM groups. Orthogonal multiplexing is achieved between CSI-RS ports in each CDM group via an OCC with a length being 4. Orthogonal multiplexing is achieved between different CDM groups via TDM or FDM.

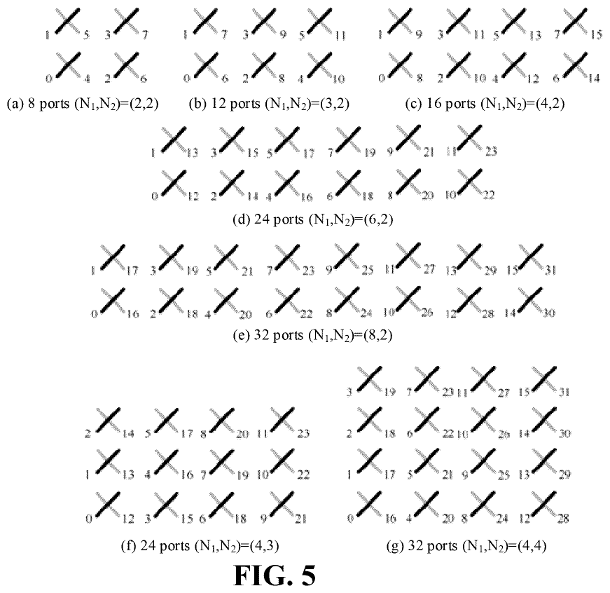

FIG. 5 is a schematic diagram of an antenna mode (array). As shown in FIG. 5, in the NR system, a terminal side may determine implementation of the antenna pattern shown in FIG. 5 via the different port numbers in a resource configuration and code-book parameter (N1, N2) in a report configuration, and calculate and determine information such as a PMI (Precoding Matrix Indicator) in CSI according to the pattern.

Currently, the CSI-RS resource configuration is an RRC semi-static configuration, and the number of CSI-RS ports and time-frequency positions will not change within a long period of time. To achieve the purpose of network energy saving, a feasible solution is that a network device adjusts an antenna configuration for serving a terminal equipment according to real-time demands of a network, such as the number of antenna elements, antenna ports, etc.

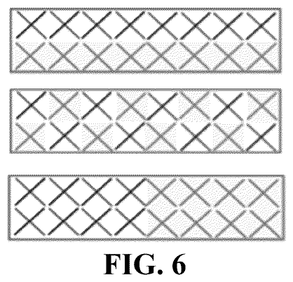

FIG. 6 is a schematic diagram of three antenna configurations. As shown in FIG. 6, a network device initially configures a 32-port CSI-RS for channel measurement for a terminal equipment. Subsequently, the network device readjusts antenna configuration, for example, from the perspective of energy saving, turning off some antenna panels or turning off some antenna factors, etc. After adjustment, the network device is changed to use a 16-port CSI-RS to serve the terminal equipment. To adaptively and dynamically adjust/turn off the 16 ports therein, there are three possible antenna patterns as shown in FIG. 6.

Since a spatial-domain beam in precoding feedback is generated and reported based on a DFT (Discrete Fourier Transformation) codebook of a vertical and horizontal equidistant antenna, the intermediate adjustment/turn-off mode in FIG. 6 may not be applicable to a real NR CSI feedback mechanism. Therefore, in order to more match a NR codebook design and an actual deployment mode, antenna array patterns actually turned off/adjusted by the network device may be limited.

In addition, for two antenna patterns that may possibly appear in FIG. 6 (that is, the upper and lower antenna patterns in FIG. 6), although there may be no significant difference in the implementation of the network device, they may be applicable to different deployment scenarios, and there may be different performance references for actual channel quality and precoding generation. Therefore, before obtaining channel quality of all antenna patterns, the network device is only based on the implementation to directly configure antenna patterns for each port number after adjustment, which will greatly reduce flexibility of the adjustment and universality of different scenarios.

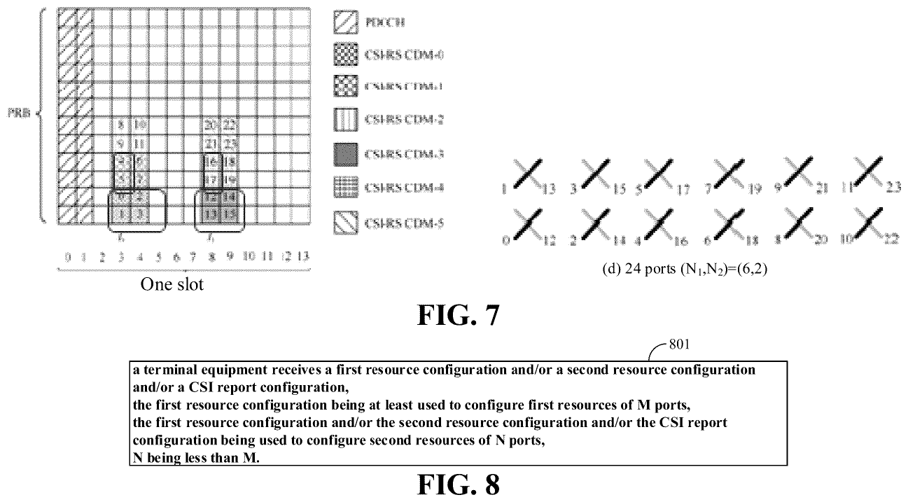

FIG. 7 is a schematic diagram of port mapping under an antenna OFF pattern. As shown in FIG. 7, after 16 ports in 32 ports are turned off, CSI-RS resource mapping is not simply the first 16 REs, which is completely different from the traditional 16-port resource mapping. Therefore, if no restrictions are imposed based on resource mapping of initial antenna ports and adjusted antenna ports, the terminal equipment may not be able to obtain adjusted CSI-RS resources within the limited antenna pattern specification, thereby it is impossible to accurately measure an adjusted channel state, and the data transmission performance cannot be guaranteed.

Therefore, when the network device adjusts an antenna configuration (for example, for the purpose of energy saving), how to enable the terminal device to perform CSI measurement efficiently and accurately has become an urgent problem to be solved in network energy saving technologies.

Various implementations of the embodiments of the present disclosure will be described below with reference to the drawings.

In the embodiments of the present disclosure, by taking the reference signal being a CSI-RS as an example, the reference signal resource may also be called a CSI-RS resource or a resource, and the resource configuration may also be called a CSI-RS resource configuration; the present disclosure is not limited to this. Furthermore, the embodiments of the present disclosure are described by taking energy saving as an example, but are not limited to this, and may be applied to any scenario involving CQI (Channel Quality Indicator) calculation or CSI measurement.

### Embodiments of a First Aspect

Embodiments of the present disclosure provide a method for configuring channel state information, which is described from a terminal equipment side. FIG. 8 is a schematic diagram of a method for configuring channel state information in the embodiments of the present disclosure. As shown in FIG. 8, the method includes:
801, a terminal equipment receives a first resource configuration and/or a second resource configuration and/or a CSI report configuration,
the first resource configuration being at least used to configure first resources of M ports,
the first resource configuration and/or the second resource configuration and/or the CSI report configuration being used to configure second resources of N ports,
N being less than M.

It should be noted that the above FIG. 8 only schematically describes the embodiments of the present disclosure, but the present disclosure is not limited to this. For example, an execution step of each operation may be adjusted appropriately, moreover other some operations may be increased or operations therein may be reduced. Persons skilled in the art may make appropriate modifications according to the above contents, not limited to the records in the above FIG. 8.

In the above embodiments, at least two of the first resource configuration, the second resource configuration and the CSI report configuration may be carried by the same RRC signaling, or may be carried by different pieces of RRC signaling respectively. Moreover, the first resource configuration, the second resource configuration and the CSI report configuration may be different configurations or may be included in the same configuration. Embodiments of the present disclosure do not impose limitations in this regard.

According to the above embodiments, when the network device adjusts an antenna configuration, which may match an actually deployed antenna adjustment more dynamically, so as to enable the terminal equipment to perform CSI measurement efficiently and accurately, thereby providing accurate channel information for the scheduling of the network device.

In some embodiments, the first resource configuration includes:
port number indication information of the M ports; and/or
resource mapping information for determining time-domain resources and/or frequency-domain resources and/or spatial-domain resources of the M ports.

In the above embodiments, the terminal equipment receives the first resource configuration, first resource of M ports and corresponding resource mapping may be determined based on the first resource configuration.

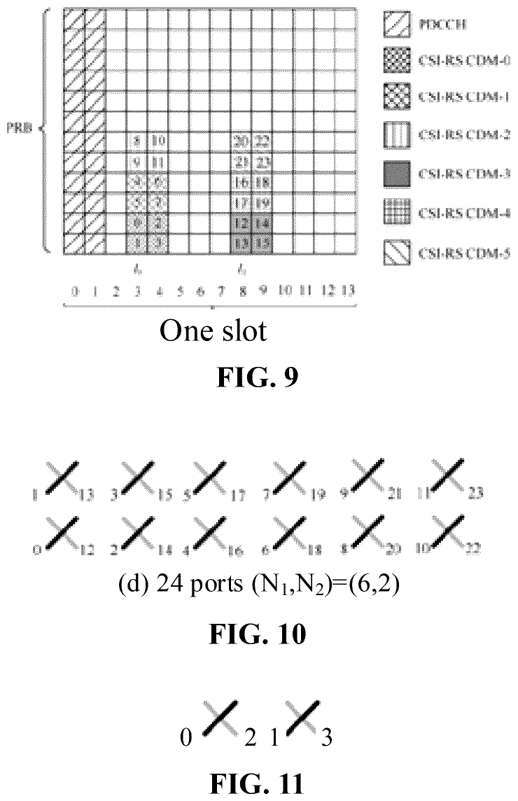

FIG. 9 is a schematic diagram of a first resource of 24 ports. As shown in FIG. 9, in this example, M=24 may be determined by “nrofPorts=24” in the RRC signaling. For a method that the terminal equipment determines the first resources of M ports based on the first resource configuration, relevant technologies may be referred to.

In some embodiments, the CSI report configuration includes:
(N1, N2) information of the first resources of M ports; and/or,
(N1′, N2′) information of the second resources of N ports.

In the above embodiments, (N1, N2) represents the number of antenna ports based on a first dimension (horizontal dimension) and a second dimension (vertical dimension) on one polarization direction in the first resources of M ports, and (N1′, N2^{T}) represents the number of antenna ports based on a first dimension (horizontal dimension) and a second dimension (vertical dimension) on one polarization direction in the second resources of N ports.

In the above embodiments, the terminal equipment receives the CSI report configuration, antenna arrays information of the first resource of M ports may be determined based on a codebook parameter (N1, N2) of the M ports in the CSI report configuration. Still taking the first resource of 24 ports shown in FIG. 9 as an example, according to the above embodiments, the terminal equipment may determine antenna array information shown in FIG. 10.

In the above embodiments, optionally, the CSI report configuration may further include a codebook parameter of the second resources of N ports, i.e., (N1′, N2′) information, thereby the terminal equipment may determine a pattern of an adjusted antenna array.

In some embodiments, the second resource configuration includes:
port indication information for indicating the second resources of N ports.

In the above embodiments, after the network device configures the first resources of M ports for the terminal equipment via the first resource configuration, if the network device needs to turn off certain antenna ports according to a need, such as a need for energy saving, the network device may adjust the first resources of M ports to the second resources of N ports to provide services to the terminal equipment via the N ports. In this situation, the network device may indicate port indication information of the second resources of N ports via the second resource configuration.

In the above embodiments, the port indication information may be related to one or more of the following configurations:
port number indication information of the M ports configured in the first resource configuration;
(N1, N2) information of the first resources of M ports configured in the CSI report configuration; and
(N1′, N2′) information of the second resources of N ports configured in the CSI report configuration.

For example, for different M and (N1, N2), there are different possible patterns of N-port antenna arrays (referred to as antenna patterns for short).

Tables 1 to 7 below show possibilities of indication patterns of all antenna ports after M ports being adjusted to N ports under different M and (N1, N2).

TABLE 1
‘nrofPorts’ = 4, (N1, N2) = (2, 1)

| Maximum pattern | | Antenna port |
|---|---|---|
| types | N or (N1′, N2′) | indications |
| 2 | 2 (1, 1) | 1010 |
| | | 0101 |

In the above example, in a case where M=4 and (N1, N2)=(2,1), that is, a network device configures first resource of 4 ports, then according to a need, in a case where the network device adjusts the first resource of 4 ports, a value of N may be indicated via the second resource configuration, or a value of (N1′, N2′) may be indicated via the CSI report configuration. If N=2 or (N1′, N2′)=(1, 1), there are two possible adjustment patterns in total, each adjustment pattern corresponds to an antenna port indication, two antenna port indications correspond to two antenna units shown in FIG. 11 (each antenna unit consists of two mutually polarized antenna port groups, such as one “X” in FIG. 10).

TABLE 2
‘nrofPorts’ = 4, (N1, N2) = (1, 2)

| Maximum pattern | | Antenna port |
|---|---|---|
| types | N or (N1′, N2′) | indications |
| 2 | 2 (1, 1) | 1010 |
| | | 0101 |

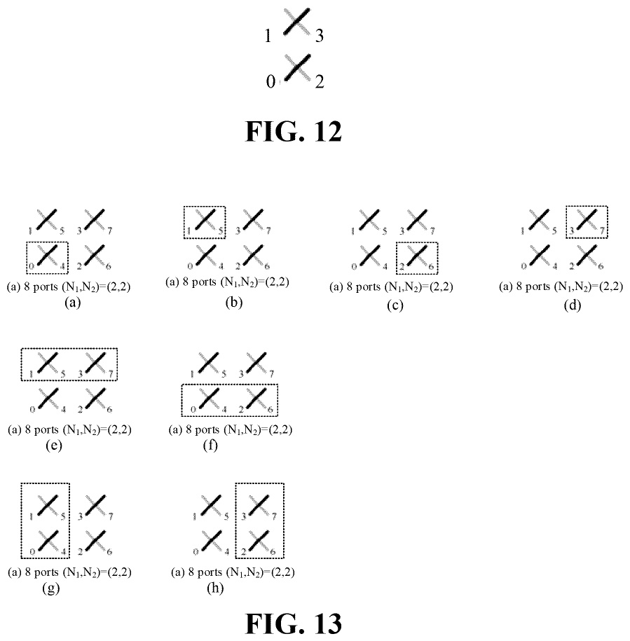

In the above example, in a case where M=4 and (N1, N2)=(1,2), that is, a network device configures first resource of 4 ports, then according to a need, in a case where the network device adjusts the first resource of 4 ports, a value of N may be indicated via the second resource configuration, or a value of (N1′, N2′) may be indicated via the CSI report configuration. If N=2 or (N1′, N2′)=(1, 1), there are two possible adjustment patterns in total, each adjustment pattern corresponds to an antenna port indication, two antenna port indications correspond to two antenna units shown in FIG. 12.

TABLE 3
‘nrofPorts’ = 8, (N1, N2) = (2, 2)

| Maximum pattern | | Antenna port |
|---|---|---|
| types | N or (N1′, N2′) | indications |
| 4 | 2 (1, 1) | 10001000 |
| | | 01000100 |
| | | 00100010 |
| | | 00010001 |
| 2 | 4 (2, 1) | 01010101 |
| | | 10101010 |
| 2 | 4 (1, 2) | 11001100 |
| | | 00110011 |

In the above example, in a case where M=8 and (N1, N2)=(2,2), that is, a network device configures first resource of 8 ports, then according to a need, in a case where the network device adjusts the first resource of 8 ports, a value of N may be indicated via the second resource configuration, or a value of (N1′, N2′) may be indicated via the CSI report configuration. If N=2 or (N1′, N2′)=(1, 1), there are four possible patterns in total, each adjustment pattern corresponds to an antenna port indication, four antenna port indications respectively correspond to four types of antenna arrays (a) to (d) in FIG. 13 (patterns circled by a rectangular box). If N=4 or (N1′, N2′)=(2, 1), there are two adjustment patterns in total, each adjustment pattern corresponds to an antenna port indication, two antenna port indications respectively correspond to two types of antenna arrays (e) to (f) in FIG. 13 (patterns circled by a rectangular box). If N=4 or (N1′, N2′)=(1, 2), there are two possible adjustment patterns in total, each adjustment pattern corresponds to an antenna port indication, two antenna port indications respectively correspond to two types of antenna arrays (g) to (h) in FIG. 13 (patterns circled by a rectangular box).

TABLE 4
‘nrofPorts’ = 12, (N1, N2) = (3, 2)

| Maximum pattern | | Antenna port |
|---|---|---|
| types | N or (N1′, N2′) | indications |
| 6 | 2 (1, 1) | 100000100000 |
| | | 010000010000 |
| | | 001000001000 |
| | | 000100000100 |
| | | 000010000010 |
| | | 000001000001 |
| 4 | 4 (2, 1) | 010100010100 |
| | | 101000101000 |
| | | 001010000101 |
| | | 100010100010 |
| | | 010001010001 |
| | | 001010000101 |
| 3 | 4 (1, 2) | 110000110000 |
| | | 001100001100 |
| | | 000011000011 |
| 3 | 8 (2, 2) | 111100111100 |
| | | 110011110011 |
| | | 001111001111 |

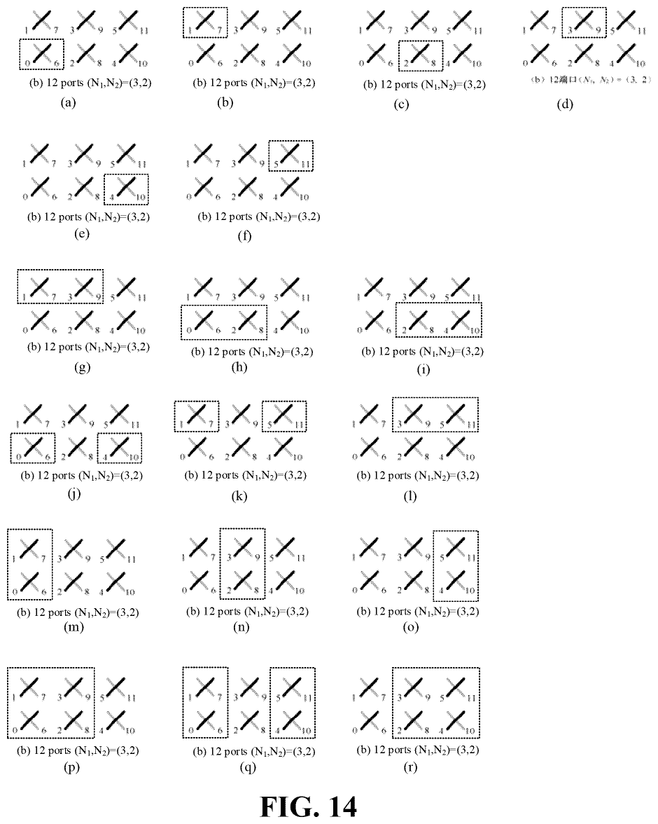

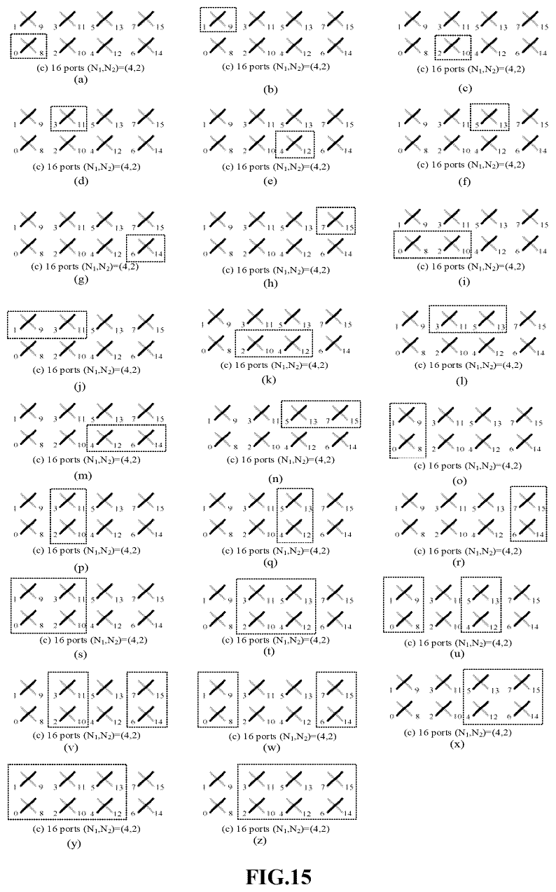

In the above example, in a case where M=12 and (N1, N2)=(3, 2), that is, a network device configures first resource of 12 ports, then according to a need, in a case where the network device adjusts the first resource of 12 ports, a value of N may be indicated via the second resource configuration, or a value of (N1′, N2′) may be indicated via the CSI report configuration. If N=2 or (N1′, N2′)=(1, 1), there are six possible adjustment patterns in total, each adjustment pattern corresponds to an antenna port indication, six antenna port indications respectively correspond to six types of antenna arrays (a) to (f) in FIG. 14 (patterns circled by a rectangular box). If N=4 or (N1′, N2′)=(2, 1), there are six possible adjustment patterns in total, each adjustment pattern corresponds to an antenna port indication, six antenna port indications correspond to six types of antenna arrays (g) to (l) in FIG. 14 (patterns circled by a rectangular box). If N=4 or (N1′, N2′)=(1, 2), there are three possible adjustment patterns in total, each adjustment pattern corresponds to an antenna port indication, three antenna port indications respectively correspond to three types of antenna arrays (m) to (o) in FIG. 14 (patterns circled by a rectangular box). If N=8 or (N1′, N2′)=(2, 2), there are three possible adjustment patterns in total, each adjustment pattern corresponds to an antenna port indication, three antenna port indications respectively correspond to three types of antenna arrays (p) to (r) in FIG. 14 (patterns circled by a rectangular box).

TABLE 5
‘nrofPorts’ = 16, (N1, N2) = (4, 2)

| Maximum pattern | | Antenna port |
|---|---|---|
| types | N or (N1′, N2′) | indications |
| 8 | 2 (1, 1) | 1000000010000000 |
| | | 0100000001000000 |
| | | 0010000000100000 |
| | | 0001000000010000 |
| | | 0000100000001000 |
| | | 0000010000000100 |
| | | 0000001000000010 |
| | | 0000000100000001 |
| 6 | 4 (2, 1) | 1010000010100000 |
| | | 0101000001010000 |
| | | 0010100000101000 |
| | | 0001010000010100 |
| | | 0000101000001010 |
| | | 0000010100000101 |
| 4 | 4 (1, 2) | 1100000011000000 |
| | | 0011000000110000 |
| | | 0000110000001100 |
| | | 0000001100000011 |
| 6 | 8 (2, 2) | 1111000011110000 |
| | | 0011110000111100 |
| | | 1100110011001100 |
| | | 0011001100110011 |
| | | 1100001111000011 |
| | | 0000111100001111 |
| 2 | 12 (3, 2) | 1111110011111100 |
| | | 0011111100111111 |

In the above example, in a case where M=16 and (N1, N2)=(4, 2), that is, a network device configures first resource of 16 ports, then according to a need, in a case where the network device adjusts the first resource of 16 ports, a value of N may be indicated via the second resource configuration, or a value of (N1′, N2′) may be indicated via the CSI report configuration. If N=2 or (N1′, N2′)=(1, 1), there are eight possible adjustment patterns in total, each adjustment pattern corresponds to an antenna port indication, eight antenna port indications respectively correspond to eight types of antenna arrays (a) to (h) in FIG. 15 (patterns circled by a rectangular box). If N=4 or (N1′, N2′)=(2, 1), there are six possible adjustment patterns in total, each adjustment pattern corresponds to an antenna port indication, six antenna port indications correspond to six types of antenna arrays (i) to (n) in FIG. 15 (patterns circled by a rectangular box). If N=4 or (N1′, N2′)=(1, 2), there are four possible adjustment patterns in total, each adjustment pattern corresponds to an antenna port indication, four antenna port indications respectively correspond to four types of antenna arrays (o) to (r) in FIG. 15 (patterns circled by a rectangular box). If N=8 or (N1′, N2′)=(2, 2), there are six possible adjustment patterns in total, each adjustment pattern corresponds to an antenna port indication, six antenna port indications respectively correspond to six types of antenna arrays (s) to (x) in FIG. 15 (patterns circled by a rectangular box). If N=12 or (N1′, N2′)=(3, 2), there are two possible adjustment patterns in total, each adjustment pattern corresponds to an antenna port indication, two antenna port indications respectively correspond to two types of antenna arrays (y) to (z) in FIG. 15 (patterns circled by a rectangular box).

TABLE 6
‘nrofPorts’ = 24, (N1, N2) = (6, 2)

| Maximum pattern | N or (N1′, | |
|---|---|---|
| types | N2′) | Antenna port indications |
| 12 | 2(1, 1) | 100000000000100000000000 |
| | | 010000000000010000000000 |
| | | 001000000000001000000000 |
| | | 000100000000000100000000 |
| | | 000010000000000010000000 |
| | | 000001000000000001000000 |
| | | 000000100000000000100000 |
| | | 000000010000000000010000 |
| | | 000000001000000000001000 |
| | | 000000000100000000000100 |
| 10 | 4 (2, 1) | 101000000000101000000000 |
| | | 010100000000010100000000 |
| | | 001010000000001010000000 |
| | | 000101000000000101000000 |
| | | 000010100000000010100000 |
| | | 000001010000000001010000 |
| | | 000000101000000000101000 |
| | | 000000010100000000010100 |
| | | 000000001010000000001010 |
| | | 000000000101000000000101 |
| 6 | 4 (1, 2) | 110000000000110000000000 |
| | | 00110000000000110000000000 |
| | | 00001100000000001100000000 |
| | | 00000011000000000011000000 |
| | | 00000000110000000000110000 |
| | | 00000000001100000000001100 |
| 16 | 8 (2, 2) | 110110000000110110000000 |
| | | 011011000000011011000000 |
| | | 001101100000001101100000 |
| | | 000110110000000110110000 |
| | | 000011011000000011011000 |
| | | 000001101100000001101100 |
| | | 000000110110000000110110 |
| | | 000000011011000000011011 |
| | | 110000110000000000110000 |
| | | 011000011000000000011000 |
| | | 000110000110000000000110 |
| | | 000011000011000000000011 |
| | | 110000000110000000000110 |
| | | 011000000011000000000011 |
| | | 101000101000101000101000 |
| | | 000101000101000101000101 |
| 4 | 12 (3, 2) | 110110110000110110110000 |
| | | 011011011000011011011000 |
| | | 000110110110000110110110 |
| | | 000011011011000011011011 |
| 2 | 16 (4, 2) | 111111110000111111110000 |
| | | 001111111100001111111100 |
| | | 000011111111000011111111 |

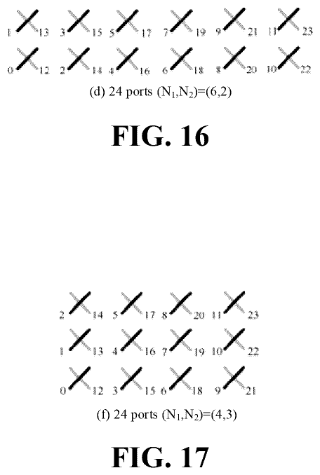

In the above example, in a case where M=24 and (N1, N2)=(6,2), that is, a network device configures first resource of 24 ports, then according to a need, in a case where the network device adjusts the first resource of 24 ports, a value of N may be indicated via the second resource configuration, or a value of (N1′, N2′) may be indicated via the CSI report configuration. If N=2 or (N1′, N2′)=(1, 1), there are twelve possible adjustment patterns in total, each adjustment pattern corresponds to an antenna port indication, twelve antenna port indications correspond to a situation of traversing one antenna unit in the antenna array shown in FIG. 16. If N=4 or (N1′, N2′)=(2, 1), there are ten possible adjustment patterns in total, each adjustment pattern corresponds to an antenna port indication, ten antenna port indications correspond to a situation of traversing two antenna units existed in a horizontal dimension in the antenna array shown in FIG. 16. If N=4 or (N1′, N2′)=(1, 2), there are six possible adjustment patterns in total, each adjustment pattern corresponds to an antenna port indication, six antenna port indications respectively correspond to a situation of traversing two antenna units existed in a vertical dimension in the antenna array shown in FIG. 16. If N=8 or (N1′, N2′)=(2, 2), there are sixteen possible adjustment patterns in total, each adjustment pattern corresponds to an antenna port indication, sixteen antenna port indications respectively correspond to a situation of traversing four antenna units (two antenna units in a horizontal dimension and two antenna units in a vertical dimension) in the antenna array shown in FIG. 16. If N=12 or (N1′, N2′)=(3, 2), there are four possible adjustment patterns in total, each adjustment pattern corresponds to an antenna port indication, four antenna port indications respectively correspond to a situation of traversing six antenna units (three antenna units in a horizontal dimension and three antenna units in a vertical dimension) in the antenna array shown in FIG. 16. If N=16 or (N1′, N2′)=(4, 2), there are two possible adjustment patterns in total, each adjustment pattern corresponds to an antenna port indication, two antenna port indications respectively correspond to a situation of traversing eight antenna units (four antenna units in a horizontal dimension and four antenna units in a vertical dimension) in the antenna array shown in FIG. 16.

TABLE 7
‘nrofPorts’ = 24, (N1, N2) = (4, 3)

| Maximum pattern | N or (N1′, | |
|---|---|---|
| types | N2′) | Antenna port indications |
| 12 | 2 (1, 1) | 100000000000100000000000 |
| | | 010000000000010000000000 |
| | | 001000000000001000000000 |
| | | 000100000000000100000000 |
| | | 000010000000000010000000 |
| | | 000001000000000001000000 |
| | | 000000100000000000100000 |
| | | 000000010000000000010000 |
| | | 000000001000000000001000 |
| | | 000000000100000000000100 |
| 9 | 4 (2, 1) | 101000000000101000000000 |
| | | 010100000000010100000000 |
| | | 001010000000001010000000 |
| | | 000101000000000101000000 |
| | | 000010100000000010100000 |
| | | 000001010000000001010000 |
| | | 000000101000000000101000 |
| | | 000000010100000000010100 |
| | | 000000001010000000001010 |
| 6 | 4 (1, 2) | 110000000000110000000000 |
| | | 00110000000000110000000000 |
| | | 00001100000000001100000000 |
| | | 00000011000000000011000000 |
| | | 00000000110000000000110000 |
| | | 00000000001100000000001100 |
| 14 | 8 (2, 2) | 110110000000110110000000 |
| | | 011011000000011011000000 |
| | | 001101100000001101100000 |
| | | 000110110000000110110000 |
| | | 000011011000000011011000 |
| | | 000001101100000001101100 |
| | | 000000110110000000110110 |
| | | 000000011011000000011011 |
| | | 110000110000000000110000 |
| | | 011000011000000000011000 |
| | | 000110000110000000000110 |
| | | 000011000011000000000011 |
| | | 110000000110000000000110 |
| | | 011000000011000000000011 |
| 4 | 12 (3, 2) | 110110110000110110110000 |
| | | 011011011000011011011000 |
| | | 000110110110000110110110 |
| | | 000011011011000011011011 |
| 3 | 12 (2, 3) | 111111000000111111000000 |
| | | 000111111000000111111000 |
| | | 000000111111000000111111 |
| 2 | 16 (4, 2) | 110110110110110110110110 |
| | | 011011011011011011011011 |

In the above example, in a case where M=24 and (N1, N2)=(4, 3), that is, a network device configures first resource of 24 ports, then according to a need, in a case where the network device adjusts the first resource of 24 ports, a value of N may be indicated via the second resource configuration, or a value of (N1′, N2′) may be indicated via the CSI report configuration. If N=2 or (N1′, N2′)=(1, 1), there are twelve possible adjustment patterns in total, each adjustment pattern corresponds to an antenna port indication, twelve antenna port indications correspond to a situation of traversing one antenna unit in the antenna array shown in FIG. 17. If N=4 or (N1′, N2′)=(2, 1), there are nine possible adjustment patterns in total, each adjustment pattern corresponds to an antenna port indication, nine antenna port indications correspond to a situation of traversing two antenna units existed in a horizontal dimension in the antenna array shown in FIG. 17. If N=4 or (N1′, N2′)=(1, 2), there are six possible adjustment patterns in total, each adjustment pattern corresponds to an antenna port indication, six antenna port indications respectively correspond to a situation of traversing two antenna units existed in a vertical dimension in the antenna array shown in FIG. 17. If N=8 or (N1′, N2′)=(2, 2), there are fourteen possible adjustment patterns in total, each adjustment pattern corresponds to an antenna port indication, fourteen antenna port indications respectively correspond to a situation of traversing four antenna units (two antenna units in a horizontal dimension and two antenna units in a vertical dimension) in the antenna array shown in FIG. 17. If N=12 or (N1′, N2′)=(3, 2), there are four possible adjustment patterns in total, each adjustment pattern corresponds to an antenna port indication, four antenna port indications respectively correspond to a situation of traversing six antenna units (three antenna units in a horizontal dimension and three antenna units in a vertical dimension) in the antenna array shown in FIG. 17. If N=12 or (N1′, N2′)=(2, 3), there are three possible adjustment patterns in total, each adjustment pattern corresponds to an antenna port indication, three antenna port indications respectively correspond to a situation of traversing six antenna units (three antenna units in a horizontal dimension and three antenna units in a vertical dimension) in the antenna array shown in FIG. 17. If N=16 or (N1′, N2′)=(4, 2), there are two possible adjustment patterns in total, each adjustment pattern corresponds to an antenna port indication, two antenna port indications respectively correspond to a situation of traversing eight antenna units (four antenna units in a horizontal dimension and four antenna units in a vertical dimension) in the antenna array shown in FIG. 17.

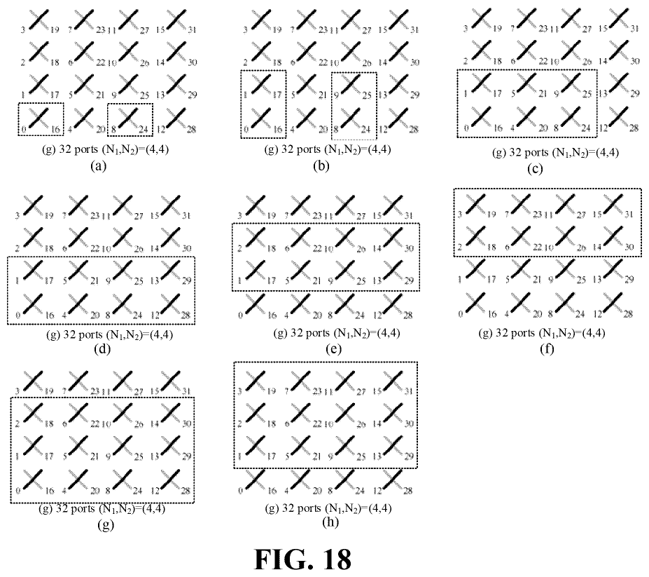

The above text only takes M=4, M=8, M=12, M=16, M=24 as examples to describe adjustment patterns (antenna patterns) of an M-port antenna array, the present disclosure is not limited to this. For the case of M=32, it is similar to that described above. For example, when M=32 and (N1, N2)=(4, 4), if the effect of dual polarization is not taken into account, there are 16 elements (array elements) in total for the 32 ports. Maximum pattern combination mode when it is adjusted to the following port is shown in FIG. 18, including:
N=2, (N1′, N2′)=(1, 1), bitmap1 where elements are located may be expressed as (00 . . . 01 . . . 0.0), with a length being 16 and an index value being (0, 1, . . . 15). Index value where “1” is located is w, a value of w ranges from 0 to 15, the bitmap where all antenna port indications are located may be represented as: a length is 32, the first 16 bits are bitmap1, the last 16 bits are also bitmap1, which may be denoted as (bitmap1, bitmap1). There are 16 types of maximum pattern combinations in total.
N=4, (N1′, N2′)=(2, 1), bitmap1 where elements are located may be expressed as (00 . . . 010 . . . 010 . . . 0), with a length being 16 and an index value being (0, 1, . . . 15). Index values where “1” is located are w1, w2, w1 is 0 to 11, w2 is 4 to 15, and w2−w1=4, 8, 12. The bitmap2 where all antenna port indications are located may be represented as (bitmap1, bitmap1), with a length being 32, the first 16 bits being bitmap1 and the last 16 bits being also bitmap1. For example: w1=0, w2=8, bitmap2 is (100000010000000100000010000000), expressed as ports 0, 8, 16, 24, the indication pattern is shown in (a) of FIG. 18.
N=8, (N1′, N2′)=(2, 2), bitmap1 where elements are located may be expressed as (01 . . . 010 . . . 010 . . . 10), with a length being 16 and an index value being (0, 1, . . . 15). Index values where “1” is located are w1, w2, w3, w4, w1 and w2 are respectively 0 to 11, w3 and w4 are respectively 4 to 15, and w3−w1=4, 8, 12, w2−w1=1, 2, 3, w4-w3=1, 2, 3, and w4>w3>w2>w1. The bitmap2 where all antenna port indications are located may be represented as (bitmap1, bitmap1), with a length being 32, the first 16 bits being bitmap1 and the last 16 bits being also bitmap1. For example: w1=0, w2=1, w3=8, w4=9, bitmap2 is (110000011000000110000011000000), expressed as ports 0, 1, 8, 9, 16, 17, 24, 25, the indication pattern is shown in (b) of FIG. 18.
N=12, (N1′, N2′)=(3, 2), bitmap1 where elements are located may be expressed as (01..10 . . . 010..010.10..10), with a length being 16 and an index value being (0, 1, . . . 15). Index values where “1” is located are w1, w2, w3, w4, w5, w6, w1 and w2 are respectively 0 to 7, w3 and w4 are respectively 4 to 11, w5 and w6 are respectively 8 to 15, and w5−w3=4, 8, w3−w1=4, 8, w2−w1=1, 2, 3, w4−w3=1, 2, 3, w6−w5=1, 2, 3, and w6>w5>w4>w3>w2>w1. The bitmap2 where all antenna port indications are located may be represented as (bitmap1, bitmap1), with a length being 32, the first 16 bits being bitmap1 and the last 16 bits being also bitmap1. For example, w1=0, w2=1, w3=4, w4=5, w5=8, w6=9, bitmap2 is (11001100110000001100110011000000), expressed as ports 0, 1, 4, 5, 8, 9, 16, 17, 20, 21, 24, 25, the indication pattern is shown in (c) of FIG. 18.
N=16, (N1′, N2′)=(4, 2), bitmap2 where all antenna port indications are located may be expressed as (d), (e), (f) shown in FIG. 18. The bitmap2 corresponding to (d) is “11001100110011001100110011001100”, the bitmap2 corresponding to (e) is “01100110011001100110011001100110”, and the bitmap2 corresponding to (f) is “00110011001100110011001100110011”.
N=24, (N1′, N2′)=(4, 2), bitmap2 where all antenna port indications are located may be expressed as (g) and (h) shown in FIG. 18. The bitmap2 corresponding to (g) is “11101110111011101110111011101110”, and the bitmap2 corresponding to (h) is “01110111011101110111011101110111”.

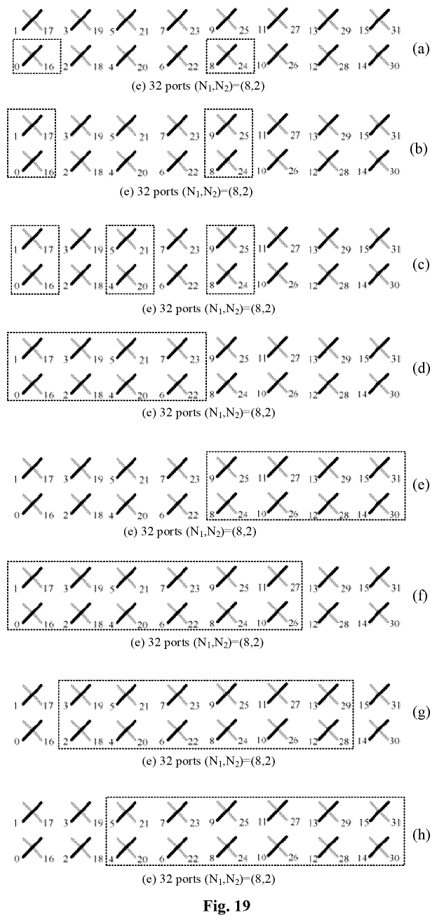

For another example, when M=32 and (N1, N2)=(8, 2), if the effect of dual polarization is not taken into account, there are 16 elements (array elements) in total for the 32 ports. Maximum pattern combination mode when it is adjusted to the following port is shown in FIG. 19, including:
N=2, (N1′, N2′)=(1, 1), bitmap1 where elements are located may be expressed as (00 . . . 01 . . . 0.0), with a length being 16 and an index value being (0, 1, . . . 15). The index value where “1” is located is w, a value of w ranges from 0 to 15, the bitmap where all antenna port indications are located may be represented as: a length is 32, the first 16 bits are bitmap1, the last 16 bits are also bitmap1, which may be denoted as (bitmap1, bitmap1). There are 16 types of maximum pattern combinations in total.
N=4, (N1′, N2′)=(2, 1), bitmap1 where elements are located may be expressed as (00 . . . 010 . . . 010 . . . 0), with a length being 16 and an index value being (0, 1, . . . 15), wherein index values where “1” is located are w1, w2, w1 is 0 to 11, w2 is 4 to 15, and w2−w1=2, 4, 6, 8, 10, 12, 14. The bitmap2 where all antenna port indications are located may be represented as (bitmap1, bitmap1), with a length being 32, the first 16 bits being bitmap1 and the last 16 bits being also bitmap1. For example, w1=0, w2=8, bitmap2 is (100000010000000100000010000000), expressed as ports 0, 8, 16, 24, the indication pattern is shown in (a) of FIG. 19.
N=8, (N1′, N2′)=(2, 2), bitmap1 where elements are located may be expressed as (01 . . . 010 . . . 010 . . . 10), with a length being 16 and an index value being (0, 1, . . . 15). Index values where “1” is located are w1, w2, w3, w4, w1 and w2 are respectively 0 to 11, w3 and w4 are respectively 4 to 15, and w3−w1=2, 4, 6, 8, 10, 12, 14, w2−w1=1, w4−w3=1, and w4>w3>w2>w1. The bitmap2 where all antenna port indications are located may be represented as (bitmap1, bitmap1), with a length being 32, the first 16 bits being bitmap1 and the last 16 bits being also bitmap1. For example, w1=0, w2=1, w3=8, w4=9, bitmap2 is (110000011000000110000011000000), expressed as ports 0, 1, 8, 9, 16, 17, 24, 25, the indication pattern is shown in (b) of FIG. 19.
N=12, (N1′, N2′)=(3, 2), bitmap1 where elements are located may be expressed as (01..10 . . . 010..010.10..10), with a length being 16 and an index value being (0, 1, . . . 15). Index values where “1” is located are w1, w2, w3, w4, w5, w6, w1 and w2 are respectively 0 to 7, w3 and w4 are respectively 4 to 11, w5 and w6 are respectively 8 to 15, and w5−w3=2, 4, 6, 8, 10, 12, w3−w1=2, 4, 6, 8, 10, 12, w2−w1=1, w4−w3=1, w6−w5=1, and w6>w5>w4>w3>w2>w1. The bitmap2 where all antenna port indications are located may be represented as (bitmap1, bitmap1), with a length being 32, the first 16 bits being bitmap1 and the last 16 bits being also bitmap1. For example, w1=0, w2=1, w3=4, w4=5, w5=8, w6=9, bitmap2 is (11001100110000001100110011000000), expressed as ports 0, 1, 4, 5, 8, 9, 16, 17, 20, 21, 24, 25, the indication pattern is shown in (c) of FIG. 19.
N=16, (N1′, N2′)=(4, 2), bitmap2 where all antenna port indications are located may be expressed as the following six types:
“11111111000000001111111100000000”, corresponding to (d) of FIG. 19;
“00111111110000000011111111000000”;
“00001111111100000000111111110000”;
“00000011111111000000001111111100”;
“00000000111111110000000011111111”;
“00110011001100110011001100110011”, corresponding to (e) of FIG. 19.
N=24, (N1′, N2′)=(6, 2), bitmap2 where all antenna port indications are located may be expressed as the following three types:
“11111111111100001111111111110000”, corresponding to (f) of FIG. 19;
“00111111111111000011111111111100”, corresponding to (g) of FIG. 19;
“00001111111111110000111111111111”, corresponding to (h) of FIG. 19.

In the above embodiments, an N-port antenna configuration (i.e., an antenna array pattern) may be indicated via port indication information of the second resource configuration.

In some embodiments, the port indication information may indicate all N-port antenna configurations corresponding to each adjustment, but the present disclosure is not limited to this, the port indication information may further indicate a part of all N-port antenna configurations corresponding to each adjustment.

For example, the port indication information indicates X types of N-port antenna configurations. That is, a network device predefines X types of N-port antenna configurations.

For another example, the port indication information indicates one or more of X types of N-port antenna configurations. That is, a network device predefines X types of N-port antenna configurations, and specifies one or more of them to provide service for a terminal equipment.

For another example, the port indication information indicates one of X types of N-port antenna configurations via log (X) bits. That is, a network device predefines X types of N-port antenna configurations, and specifies one of them to provide service for a terminal equipment.

For another example, the port indication information indicates Y types of X types of N-port antenna configurations via log (C_{Y}^{X}) bits. That is, a network device predefines X types of N-port antenna configurations, and specifies Y of them to provide service for a terminal equipment.

In the above examples, X is an integer greater than or equal to 1, and X≤a maximum type of antenna array combinations, where Y≤X.

In some embodiments, the port indication information is indicated via RRC signaling, but the present disclosure is not limited to this, the port indication information may further be indicated via a system-predefined method.

In some embodiments, the port indication information further includes: a correspondence between the second resources of N ports and the first resources of M ports. Thereby, the terminal equipment may confirm a relationship between the second resources of N ports after adjustment and the first resources of M ports before adjustment.

In the above embodiments, the second resources of N ports may be a part of the first resources of M ports.

For example, the second resources of N ports is time-domain resources and/or frequency-domain resources and/or spatial-domain resources corresponding to some ports of the first resources of M ports. In a network energy saving scenario, a terminal equipment may be configured with more than one CSI-RS resource in a channel measurement resource set in the CSI report configuration (CSI-ReportConfig). The second resources of N ports correspond to a spatial element/port muting mode, or a spatial element/port configuration.

In some embodiments, the terminal equipment may receive the second resource configuration via RRC signaling, or via MAC CE signaling, or via DCI indication information. The present disclosure is not limited to this, the terminal equipment may further obtain the second resource configuration via any combination of the above-mentioned signaling/information.

In some embodiments, the terminal equipment may further determine time-frequency resource information of the second resources of N ports according to the first resource configuration, the second resource configuration and the CSI report configuration.

For example, resource mapping information of the M ports is obtained according to the first resource configuration, an antenna array pattern is obtained according to the CSI report configuration, N-port antenna configuration is obtained according to the second resource configuration, and a relationship between the second resources of N ports and the first resources of M ports is further obtained according to the second resources, thereby time-frequency resource information of the second resources of N ports may be obtained.

In some embodiments, the terminal equipment may further determine time-frequency resource information of the second resources of N ports corresponding to Y types of N-port antenna configurations according to the first resource configuration, the second resource configuration and the CSI report configuration.

For example, Y types of N-port antenna configurations may be obtained according to the second resource configuration, time-frequency resource information of the M ports may be obtained according to the first resource configuration and the CSI report configuration, a relationship between the second resources of N ports and the first resources of M ports may be obtained from the second resource configuration, thereby time-frequency resource information of the second resources of N ports corresponding to the Y types of N-port antenna configurations may be further obtained.

In some embodiments, the terminal equipment may further calculate and report CSI information of the first resources of M ports and/or the second resources of N ports.

In some embodiments, the terminal equipment calculates CSI information of a set of the second resources of N ports corresponding to X types of N-port antenna configurations, and reports the second resources of N ports corresponding to one of the X types of N-port antenna configurations.

That is, in a case where the network device configures or predefines X types of N-port antenna configurations, the terminal equipment calculates CSI information corresponding to all X types of N-port antenna configurations and reports one of them.

In the above embodiments, if X=1, that is, in a case where one type of N-port antenna configuration is predefined, the terminal equipment does not report the second resources of N ports recommended to be reported.

In the above embodiments, the terminal equipment may add log(X) bits into CSI Part I to report the second resources of N ports corresponding to one of the X types of N-port antenna configurations. However, the present disclosure is not limited to this, the terminal equipment may further perform CSI report corresponding to one of the X types of N-port antenna configurations via other means.

In some embodiments, the terminal equipment calculates CSI information of a set of the second resources of N ports corresponding to Y types of N-port antenna configurations, and reports the second resources of N ports corresponding to one of the Y types of N-port antenna configurations, Y≤X.

That is, in a case where the network device configures or predefines X types of N-port antenna configurations and specifies Y types of them, the terminal equipment calculates CSI information corresponding to the Y types of N-port antenna configurations and reports one of them.

In the above embodiments, if Y=1, that is, the network device specifies one type of N-port antenna configuration, the terminal equipment does not report the second resources of N ports recommended to be reported.

In the above embodiments, the terminal equipment may add log(Y) bits into CSI Part I to report the second resources of N ports corresponding to one of the Y types of N-port antenna configurations. However, the present disclosure is not limited to this, the terminal equipment may further perform CSI report corresponding to one of the Y types of N-port antenna configurations via other means.

In some embodiments, the terminal equipment may further calculate and report CSI information of a set of the second resources of N ports corresponding to X types of N-port antenna configurations.

That is, in a case where the network device configures or predefines X types of N-port antenna configurations, regardless of whether the network device specifies one or more of the reports or not, the terminal equipment reports CSI information corresponding to the X types of N-port antenna configurations.

In some embodiments, the terminal equipment may further calculate and report CSI information of a set of the second resources of N ports corresponding to Y types of N-port antenna configurations.

That is, in a case where the network device configures or predefines X types of N-port antenna configurations and specifies Y types of them, the terminal equipment reports CSI information corresponding to the Y types of N-port antenna configurations.

In some embodiments, the terminal equipment may further calculate and report CSI information of a set of the second resources of N ports corresponding to R types of N-port antenna configurations, R≤Y.

That is, in a case where the network device configures or predefines X types of N-port antenna configurations, regardless of whether the network device specifies one or more of the reports or not, the terminal equipment performs CSI report according to its own selection.

The method in the embodiments of the present disclosure is described below via specific examples.

In some embodiments, the network device predefines an N-port antenna configuration (that is, an adjusted antenna array mode, or, an adjusted antenna pattern) via a second resource configuration.

In the above embodiments, the terminal equipment receives the second resource configuration, optionally, the terminal equipment may further determine the number of ports of the second resources of N ports based on the second resource configuration, for example, 4. The number of ports of the second resources of N ports may be determined via RRC configuration information, for example, the number of ports mentioned above may be indicated by adding “nrofPorts_N=4” in the RRC configuration information.

In the above embodiments, the terminal equipment receives the second resource configuration, this port indication information may further indicate an N-port antenna configuration, such as 4-port antenna indication information. The network device indicates and defines the adjusted antenna pattern via a predefined method.

For example, there are a total of 10 maximum antenna pattern combination modes for an antenna port to be adjusted from M=24, (N1, N2)=(4, 3) to N=4 and (N1′, N2′)=(2, 1), however due to actual antenna deployment and other reasons, in the second resource configuration, only one port selection mode (that is, one antenna pattern) is indicated via a predefined method.

The following Table 8 shows port selection specified by the network device via the second resource configuration:

TABLE 8
‘nrofPorts’ = 24, (N1, N2) = (6, 2)

| N, (N1′, N2′) | Antenna port indication |
|---|---|
| 4, (2, 1) | 101000000000101000000000 |

For another example, there are a total of 10 maximum antenna pattern combination modes for an antenna port to be adjusted from M=24, (N1, N2)=(4, 3) to (N1′, N2′)=(2, 1), however due to actual antenna deployment and other reasons, in the second resource configuration, only one port selection mode (that is, one antenna pattern) is indicated via a predefined method.

The following Table 9 shows port selection specified by the network device via the second resource configuration:

TABLE 9
‘nrofPorts’ = 24, (N1, N2) = (6, 2)

| (N1′, N2′) | Antenna port indication |
|---|---|
| (2, 1) | 101000000000101000000000 |

For another example, there are a total of 10 maximum antenna pattern combination modes corresponding to (2, 1) and 6 maximum antenna pattern combination modes corresponding to (1, 2) for an antenna port to be adjusted from M=24, (N1, N2)=(4, 3) to N=4, however due to actual antenna deployment and other reasons, in the second resource configuration, only one port selection mode (that is, one antenna pattern) is indicated via a predefined method.

The following Table 10 shows port selection specified by the network device via the second resource configuration:

TABLE 10
‘nrofPorts’ = 24, (N1, N2) = (6, 2)

| N | Antenna port indication |
|---|---|
| 4 | 101000000000101000000000 |

In the above embodiments, the terminal equipment may calculate and report the first resources based on M ports according to the first resource configuration. For specific details, relevant technologies may be referred to. In addition, the terminal equipment may further calculate and report the N port-based second resources according to the second resource configuration.

In some embodiments, the network device predefines X types of N-port antenna configurations via the second resource configuration, and configures one of the N-port antenna configurations.

In the above embodiments, the terminal equipment receives the second resource configuration, optionally, the terminal equipment may further determine the number of ports of the second resources of N ports based on the second resource configuration, for example, 4. The number of ports of the second resources of N ports may be determined via RRC configuration information, for example, the number of ports mentioned above may be indicated by adding “nrofPorts_N=4” in the RRC configuration information.

In the above embodiments, the terminal equipment receives the second resource configuration, this port indication information may further indicate an N-port antenna configuration, such as 4-port antenna indication information. The network device may configure X types of N-port antenna configurations via one of the following ways.

### Way 1:

There are a total of 10 maximum antenna pattern combination modes for an antenna port to be adjusted from M=24, (N1, N2)=(6, 2) to N=4 and (N1′, N2′)=(2, 1), however due to actual antenna deployment and other reasons, in the second resource configuration, only X=4 is configured via a predefined method, i.e., four types of 4-port antenna configurations.

The following Table 11 shows port selection specified by the network device via the second resource configuration:

TABLE 11
nrofPorts’ = 24, (N1, N2) = (6, 2)

| X | Index | N, (N1′, N2′) | Antenna port indication |
|---|---|---|---|
| 4 | 00 | 4, (2, 1) | 101000000000101000000000 |
| | 01 | | 010100000000010100000000 |
| | 10 | | 001010000000001010000000 |
| | 11 | | 000010100000000010100000 |

### Way 2:

There are a total of 10 maximum antenna pattern combination modes for an antenna port to be adjusted from M=24, (N1, N2)=(6, 2) to (N1′, N2′)=(2, 1), however due to actual antenna deployment and other reasons, in the second resource configuration, only X=4 is configured via a predefined method, i.e., four types of 4-port antenna configurations.

The following Table 12 shows port selection specified by the network device via the second resource configuration:

TABLE 12
nrofPorts’ = 24, (N1, N2) = (6, 2)

| X | Index | (N1′, N2′) | Antenna port indication |
|---|---|---|---|
| 4 | 00 | (2, 1) | 101000000000101000000000 |
| | 01 | | 010100000000010100000000 |
| | 10 | | 001010000000001010000000 |
| | 11 | | 000010100000000010100000 |

### Way 3:

There are a total of 10 maximum antenna pattern combination modes corresponding to (2, 1) and 6 maximum antenna pattern combination modes corresponding to (1, 2) for an antenna port to be adjusted from M=24, (N1, N2)=(6, 2) to N=4, however due to actual antenna deployment and other reasons, in the second resource configuration, only X=4 is configured via a predefined method, i.e., four types of 4-port antenna configurations.

The following Table 13 shows port selection specified by the network device via the second resource configuration:

TABLE 13
nrofPorts’ = 24, (N1, N2) = (6, 2)

| X | Index | N | Antenna port indication |
|---|---|---|---|
| 4 | 00 | 4 | 101000000000101000000000 |
| | 01 | | 010100000000010100000000 |
| | 10 | | 001010000000001010000000 |
| | 11 | | 000010100000000010100000 |

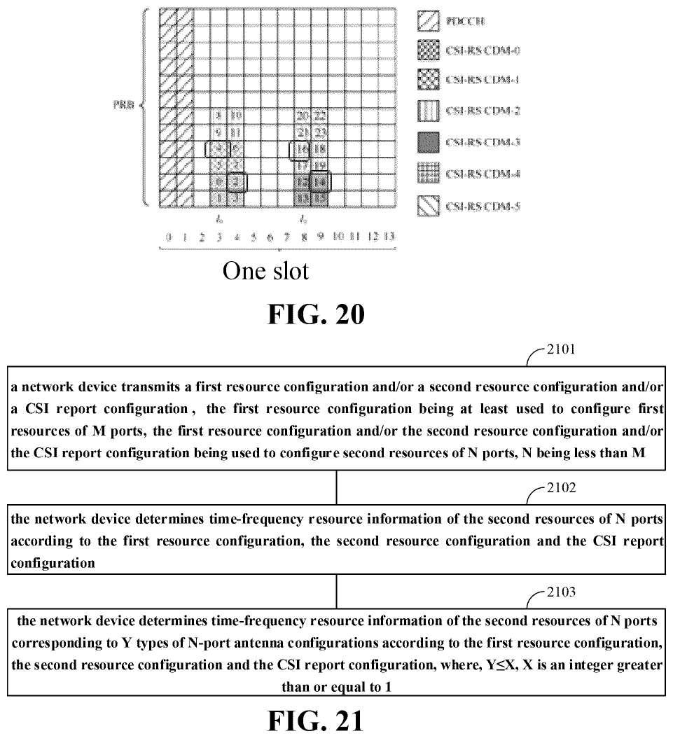

In the above embodiments, the terminal equipment may further find port selection information corresponding to the third antenna pattern in a predefined table based on the antenna port indication with the index “10” in the above Table 13, as shown in FIG. 20.

In the above embodiments, a 24-port bitmap corresponding to port selection corresponding to the above Way 3 may be represented as follows:
“001010000000001010000000”.

In addition, the terminal equipment may further determine a time-frequency position corresponding to the second resource of 4 ports according to 4-port selection information.

In the above embodiments, the number indication information (second resource configuration) of the N ports may be determined via the following ways:
system predefined;
RRC signaling;
MAC CE signaling; and
DCI indication.

The present disclosure is not limited to this, the number indication information (second resource configuration) of the N ports may further be indicated via other indication information or configured by the network device in other ways, and so on.

In the above embodiments, the terminal equipment may calculate and report the first resources based on M ports according to the first resource configuration. For specific details, relevant technologies may be referred to. In addition, the terminal equipment may further calculate and report the N port-based second resources according to the second resource configuration.

In some embodiments, the network device predefines X types of N-port antenna configurations via the second resource configuration, and the terminal equipment reports one or more of them, or the terminal equipment reports R types of N-port antenna configurations.

In the above embodiments, the terminal equipment receives the second resource configuration, optionally, the terminal equipment may further determine the number of ports of the second resources of N ports based on the second resource configuration, for example, 4. The number of ports of the second resources of N ports may be determined via RRC configuration information, for example, the number of ports mentioned above may be indicated by adding “nrofPorts_N=4” in the RRC configuration information.

In the above embodiments, the terminal equipment receives the second resource configuration, this port indication information may further indicate an N-port antenna configuration, such as 4-port antenna indication information. The network device may configure the X types of N-port antenna configurations via one of the following ways.

### Way 1:

There are a total of 10 maximum antenna pattern combination modes for an antenna port to be adjusted from M=24, (N1, N2)=(6, 2) to N=4 and (N1′, N2′)=(2, 1), however due to actual antenna deployment and other reasons, in the second resource configuration, only X=4 is configured via a predefined method, i.e., four types of 4-port antenna configurations.

The above Table 11 shows port selection specified by the network device via the second resource configuration.

### Way 2:

There are a total of 10 maximum antenna pattern combination modes for an antenna port to be adjusted from M=24, (N1, N2)=(6, 2) to (N1′, N2′)=(2, 1), however due to actual antenna deployment and other reasons, in the second resource configuration, only X=4 is configured via a predefined method, i.e., four types of 4-port antenna configurations.

The above Table 12 shows port selection specified by the network device via the second resource configuration.

### Way 3:

There are a total of 10 maximum antenna pattern combination modes corresponding to (2, 1) and 6 maximum antenna pattern combination modes corresponding to (1, 2) for an antenna port to be adjusted from M=24, (N1, N2)=(6, 2) to N=4, however due to actual antenna deployment and other reasons, in the second resource configuration, only X=4 is configured via a predefined method, i.e., four types of 4-port antenna configurations.

The above Table 13 shows port selection specified by the network device via the second resource configuration.

In the above embodiments, unlike the previous embodiments, the terminal equipment finds port selection information corresponding to all four antenna patterns in a predefined table.

In the above embodiments, the number indication information (i.e., the second resource configuration) of the N ports may be determined via the following ways:
system predefined;
RRC signaling;
MAC CE signaling; and
DCI indication.

The present disclosure is not limited to this, the number indication information (second resource configuration) of the N ports may further be indicated via other indication information or configured by the network device in other ways, and so on.

In the above embodiments, the terminal equipment may calculate and report the first resources based on M=24 ports according to the first resource configuration. For specific details, relevant technologies may be referred to. In addition, the terminal equipment may further calculate and report the second resources based on X=4 types of N=4 ports according to the second resource configuration.

In the above embodiments, the terminal equipment may select to report CSI information of a 4-port antenna pattern according to CSI measurement information, such as CSI information of the third antenna pattern in the above table. And, the terminal equipment may report the third one of X=4 antenna patterns within CSI part I. For example, report indication may be performed according to log(4)=2bits, for instance, “10” indicates the third antenna pattern.

In the above embodiments, the terminal equipment may further report CSI information of all X=4 types of 4-port antenna patterns according to CSI measurement information. For example, CSI information may be reported in sequence according to an index value of an antenna pattern corresponding to X.

In the above embodiments, the terminal equipment may further report CSI information of all R≤X types of 4-port antenna patterns according to CSI measurement information. For example, the terminal equipment may perform report indication according to X bits in CSI part I. For instance, “0011” indicates that the terminal equipment has selected to report CSI information of the third and fourth antenna patterns. For example, the terminal equipment may report CSI information in sequence according to an index value of an antenna pattern corresponding to R.

In some embodiments, the network device predefines X types of N-port antenna configurations via the second resource configuration, and configures Y types of N-port antenna configurations via RRC signaling, and the terminal equipment reports one or more of them.

In the above embodiments, the terminal equipment receives the second resource configuration, optionally, the terminal equipment may further determine the number of ports of the second resources of N ports based on the second resource configuration, for example, 4. The number of ports of the second resources of N ports may be determined via RRC configuration information, for example, the number of ports mentioned above may be indicated by adding “nrofPorts_N=4” in the RRC configuration information.

In the above embodiments, the terminal equipment receives the second resource configuration, this port indication information may further indicate an N-port antenna configuration, such as 4-port antenna indication information. The network device may configure the X types of 4-port antenna configurations via one of the following ways.

### Way 1:

There are a total of 10 maximum antenna pattern combination modes for an antenna port to be adjusted from M=24, (N1, N2)=(6, 2) to N=4 and (N1′, N2′)=(2, 1), however due to actual antenna deployment and other reasons, in the second resource configuration, only X=4 is configured via a predefined method, i.e., four types of 4-port antenna configurations.

The above Table 11 shows port selection specified by the network device via the second resource configuration.

### Way 2:

There are a total of 10 maximum antenna pattern combination modes for an antenna port to be adjusted from M=24, (N1, N2)=(6, 2) to (N1′, N2′)=(2, 1), however due to actual antenna deployment and other reasons, in the second resource configuration, only X=4 is configured via a predefined method, i.e., four types of 4-port antenna configurations.

The above Table 12 shows port selection specified by the network device via the second resource configuration.

### Way 3:

There are a total of 10 maximum antenna pattern combination modes corresponding to (2, 1) and 6 maximum antenna pattern combination modes corresponding to (1, 2) for an antenna port to be adjusted from M=24, (N1, N2)=(6, 2) to N=4, however due to actual antenna deployment and other reasons, in the second resource configuration, only X=4 is configured via a predefined method, i.e., four types of 4-port antenna configurations.

The above Table 13 shows port selection specified by the network device via the second resource configuration.

In the above embodiments, the terminal equipment may receive Y=3 configuration information via the second resource configuration, where Y≤X, and find port selection information corresponding to the first Y antenna patterns based on a predefined table.

In the above embodiments, the second resource configuration, i.e., the number indication information of the N ports and/or X and/or Y, may be determined via the following ways:
system predefined;
RRC signaling;
MAC CE signaling; and
DCI indication.

The present disclosure is not limited to this, it may further be indicated via other indication information or configured by the network device in other ways, and so on.

In the above embodiments, the terminal equipment may calculate and report the first resources based on M=24 ports according to the first resource configuration. For specific details, relevant technologies may be referred to. In addition, the terminal equipment may further calculate and report the second resources based on Y=3 types of N=4 ports according to the second resource configuration.

In the above embodiments, the terminal equipment may select to report CSI information of a 4-port antenna pattern according to CSI measurement information, such as CSI information of the third antenna pattern in the above table. And, the terminal equipment may report the second one of Y=3 antenna patterns within CSI part I. For example, report indication may be performed according to log(Y)=2bits, for instance, “10” indicates the second antenna pattern.

In the above embodiments, the terminal equipment may further report CSI information of all R≤Y types of 4-port antenna patterns according to CSI measurement information. For example, the terminal equipment may perform report indication according to Y bits in CSI part I. For instance, “011” indicates that the terminal equipment has selected to report CSI information of the second and third antenna patterns. For example, the terminal equipment may report CSI information in sequence according to an index value of an antenna pattern corresponding to R.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

As may be known from the embodiments of the present disclosure, when a network device adjusts an antenna configuration, by adding indication restrictions on some antenna ports/patterns, current CSI report is capable of more dynamically matching an actually deployed antenna adjustment. Thereby, a terminal equipment is capable of performing CSI measurement efficiently and accurately, so as to provide accurate channel information for the scheduling of the network device.

### Embodiments of a Second Aspect

Embodiments of the present disclosure provide a method for configuring channel state information, which is described from a network device side, the contents same as the embodiments of the first aspect are not repeated.

FIG. 21 is a schematic diagram of a method for configuring channel state information in the embodiments of the present disclosure, as shown in FIG. 21, the method includes:
2101, a network device transmits a first resource configuration and/or a second resource configuration and/or a CSI report configuration,
the first resource configuration being at least used to configure first resources of M ports,
the first resource configuration and/or the second resource configuration and/or the CSI report configuration being used to configure second resources of N ports,
N being less than M.

In some embodiments, the first resources and/or the second resources are at least time-domain resources and/or frequency-domain resources and/or spatial-domain resources for transmitting or receiving reference signals, and the second resources of N ports is a part of the first resources of M ports.

In some embodiments, the first resource configuration includes:
port number indication information for indicating the M ports; and/or
resource mapping information for determining time-domain resources and/or frequency-domain resources and/or spatial-domain resources of the M ports.

In some embodiments, the CSI report configuration includes:
(N1, N2) information for the first resources of M ports; and/or,
(N1′, N2′) information for the second resources of N ports.

In some embodiments, the second resource configuration includes:
port indication information for indicating the second resources of N ports.

In some embodiments, the port indication information is related to one or more of the following configurations:
a port number indication of the M ports configured in the first resource configuration;
(N1, N2) information of the first resources of M ports configured in the CSI report configuration; and
(N1′, N2′) information of the second resources of N ports configured in the CSI report configuration.

In some embodiments, the port indication information is used to indicate one or more of X types of N-port antenna configurations; where, X is an integer greater than or equal to 1.

In some embodiments, the port indication information indicates X types of N-port antenna configurations; where, X is an integer greater than or equal to 1.

In some embodiments, the port indication information indicates one of X types of N-port antenna configurations via log (X) bits; where, X is an integer greater than or equal to 1.

In some embodiments, the port indication information indicates Y types of X types of N-port antenna configurations via log (C_{Y}^{X}) bits; where, Y≤X, X is an integer greater than or equal to 1.

In some embodiments, the port indication information is indicated via RRC signaling, or the port indication information is indicated in a system-predefined method.

In some embodiments, the port indication information includes:
a correspondence between the second resources of N ports and the first resources of M ports.

In some embodiments, the network device transmits the second resource configuration via one of the following:
RRC signaling;
MAC CE signaling; and
DCI indication information.

In some embodiments, as shown in FIG. 21, the method further includes:
2102, the network device determines time-frequency resource information of the second resources of N ports according to the first resource configuration, the second resource configuration and the CSI report configuration.

In some embodiments, as shown in FIG. 21, the method further includes:
2103, the network device determines time-frequency resource information of the second resources of N ports corresponding to Y types of N-port antenna configurations according to the first resource configuration, the second resource configuration and the CSI report configuration, where, Y≤X, X is an integer greater than or equal to 1.

It should be noted that the above FIG. 21 only schematically describes the embodiments of the present disclosure, but the present disclosure is not limited to this. For example, an execution step of each operation may be adjusted appropriately, moreover other some operations may be increased or operations therein may be reduced. Persons skilled in the art may make appropriate modifications according to the above contents, not limited to the records in the above FIG. 21.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

As may be known from the embodiments of the present disclosure, when a network device adjusts an antenna configuration, by adding indication restrictions on some antenna ports/patterns, current CSI report is capable of more dynamically matching an actually deployed antenna adjustment. Thereby, a terminal equipment is capable of performing CSI measurement efficiently and accurately, so as to provide accurate channel information for the scheduling of the network device.

### Embodiments of a Third Aspect

Embodiments of the present disclosure provide an apparatus for configuring channel state information. The apparatus for example may be a terminal equipment, or may be one or more parts or components configured in the terminal equipment, contents same as the embodiments of the first aspect are not repeated.

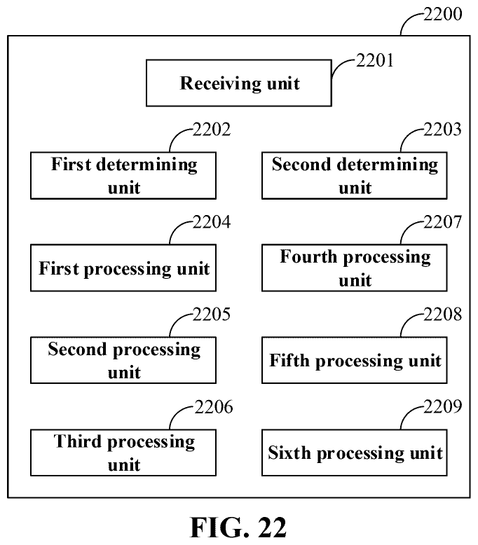

FIG. 22 is a schematic diagram of an apparatus for configuring channel state information in the embodiments of the present disclosure. As shown in FIG. 22, the apparatus 2200 for configuring channel state information in the embodiments of the present disclosure comprises:
a receiving unit 2201 configured to receive a first resource configuration and/or a second resource configuration and/or a CSI report configuration,
the first resource configuration being at least used to configure first resources of M ports,
the first resource configuration and/or the second resource configuration and/or the CSI report configuration being used to configure second resources of N ports,
N being less than M.

In some embodiments, the first resource configuration includes:
port number indication information of the M ports; and/or
resource mapping information for determining time-domain resources and/or frequency-domain resources and/or spatial-domain resources of the M ports.

In some embodiments, the CSI report configuration includes:
(N1, N2) information of the first resources of M ports; and/or,
(N1′, N2′) information of the second resources of N ports.

In some embodiments, the second resource configuration includes:
port indication information for indicating the second resources of N ports.

In some embodiments, the port indication information is related to one or more of the following configurations:
port number indication information of the M ports configured in the first resource configuration;
(N1, N2) information of the first resources of M ports configured in the CSI report configuration; and
(N1′, N2′) information of the second resources of N ports configured in the CSI report configuration.

In some embodiments, the port indication information indicates one or more of X types of N-port antenna configurations; where, X is an integer greater than or equal to 1.

In some embodiments, the port indication information indicates X types of N-port antenna configurations; where, X is an integer greater than or equal to 1.

In some embodiments, the port indication information indicates one of X types of N-port antenna configurations via log (X) bits; where, X is an integer greater than or equal to 1.

In some embodiments, the port indication information indicates Y types of X types of N-port antenna configurations via log (C_{Y}^{X}) bits; where, Y≤X, X is an integer greater than or equal to 1.

In some embodiments, the port indication information is indicated via RRC signaling, or the port indication information is indicated in a system-predefined method.

In some embodiments, the port indication information includes: a correspondence between the second resources of N ports and the first resources of M ports.

In some embodiments, the second resources of N ports is a part of the first resources of M ports.

In some embodiments, the receiving unit 2201 receives the second resource configuration via one of the following:
RRC signaling;
MAC CE signaling; and
DCI indication information.

In some embodiments, as shown in FIG. 22, the apparatus 2200 further comprises:
a first determining unit 2202 configured to determine time-frequency resource information of the second resources of N ports according to the first resource configuration, the second resource configuration and the CSI report configuration.

In some embodiments, as shown in FIG. 22, the apparatus 2200 further comprises:
a second determining unit 2203 configured to determine time-frequency resource information of the second resources of N ports corresponding to Y types of N-port antenna configurations according to the first resource configuration, the second resource configuration and the CSI report configuration, where, Y≤X, X is an integer greater than or equal to 1.

In some embodiments, as shown in FIG. 22, the apparatus 2200 further comprises:
a first processing unit 2204 configured to calculate and report CSI information of the first resources of M ports and/or the second resources of N ports.

In some embodiments, as shown in FIG. 22, the apparatus 2200 further comprises:
a second processing unit 2205 configured to calculate CSI information of a set of the second resources of N ports corresponding to X types of N-port antenna configurations, and report the second resources of N ports corresponding to one of the X types of N-port antenna configurations; where, X is an integer greater than or equal to 1.

In some embodiments, if X=1, the second processing unit 2205 does not report the second resources of N ports recommended to be reported.

In some embodiments, the second processing unit 2205 adds log(X) bits into CSI Part I to report the second resources of N ports corresponding to one of the X types of N-port antenna configurations.

In some embodiments, as shown in FIG. 22, the apparatus 2200 further comprises:
a third processing unit 2206 configured to calculate CSI information of a set of the second resources of N ports corresponding to Y types of N-port antenna configurations, and report the second resources of N ports corresponding to one of the Y types of N-port antenna configurations; where, Y≤X, X is an integer greater than or equal to 1.

In some embodiments, if Y=1, the third processing unit 2206 does not report the second resources of N ports recommended to be reported.

In some embodiments, the third processing unit 2206 adds log(Y) bits into CSI Part I to report the second resources of N ports corresponding to one of the Y types of N-port antenna configurations.

In some embodiments, as shown in FIG. 22, the apparatus 2200 further comprises:
a fourth processing unit 2207 configured to calculate and report CSI information of a set of the second resources of N ports corresponding to X types of N-port antenna configurations; where, X is an integer greater than or equal to 1.

In some embodiments, as shown in FIG. 22, the apparatus 2200 further comprises:
a fifth processing unit 2208 configured to calculate and report CSI information of a set of the second resources of N ports corresponding to Y types of N-port antenna configurations; where, Y≤X, X is an integer greater than or equal to 1.

In some embodiments, as shown in FIG. 22, the apparatus 2200 further comprises:
a sixth processing unit 2209 configured to calculate and report CSI information of a set of the second resources of N ports corresponding to R types of N-port antenna configurations; where, R≤Y, Y≤X, X is an integer greater than or equal to 1.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

It's worth noting that the above only describes components or modules related to the present disclosure, but the present disclosure is not limited to this. The apparatus 2200 for configuring channel state information may further include other components or modules. For detailed contents of these components or modules, relevant technologies may be referred to.

Moreover, for the sake of simplicity, FIG. 22 only exemplarily shows a connection relationship or signal direction between components or modules, however persons skilled in the art should know that various relevant technologies such as bus connection may be used. The above components or modules may be realized by a hardware facility such as a processor, a memory, a transmitter, a receiver, etc. The embodiments of the present disclosure have no limitation to this.

Through the embodiments of the present disclosure, when a network device adjusts an antenna configuration, by adding indication restrictions on some antenna ports/patterns, current CSI report is capable of more dynamically matching an actually deployed antenna adjustment. Thereby, a terminal equipment is capable of performing CSI measurement efficiently and accurately, so as to provide accurate channel information for the scheduling of the network device.

### Embodiments of a Fourth Aspect

Embodiments of the present disclosure provide an apparatus for configuring channel state information. The apparatus may be a network device, or may be one or more parts or components configured in the network device. The contents same as the embodiments of the first to third aspects are not repeated.

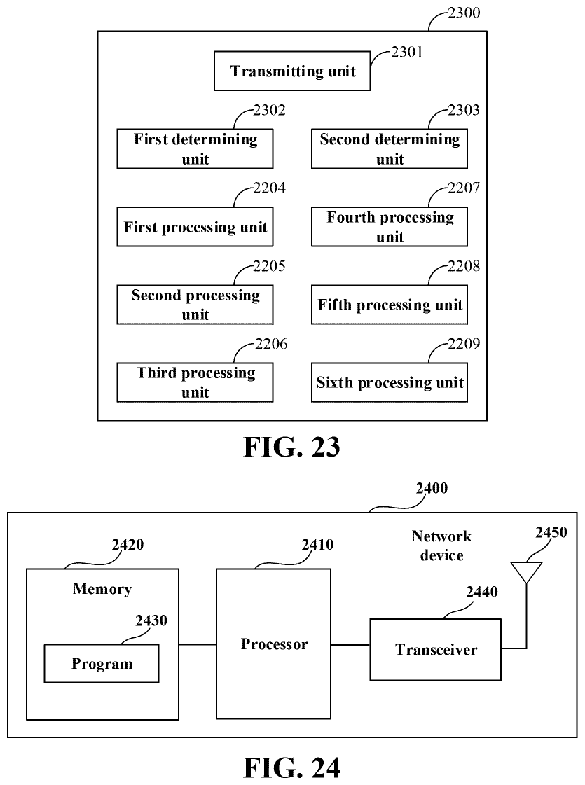

FIG. 23 is a schematic diagram of an apparatus for configuring channel state information in the embodiments of the present disclosure. As shown in FIG. 23, the apparatus 1300 for configuring channel state information in the embodiments of the present disclosure comprises:
a transmitting unit 2301 configured to transmit a first resource configuration and/or a second resource configuration and/or a CSI report configuration,
the first resource configuration being at least used to configure first resources of M ports,
the first resource configuration and/or the second resource configuration and/or the CSI report configuration being used to configure second resources of N ports,
N being less than M.

In some embodiments, the first resource configuration includes:
port number indication information for indicating the M ports; and/or
resource mapping information for determining time-domain resources and/or frequency-domain resources and/or spatial-domain resources of the M ports.

In some embodiments, the CSI report configuration includes:
(N1, N2) information for the first resources of M ports; and/or,
(N1′, N2′) information for the second resources of N ports.

In some embodiments, the second resource configuration includes:
port indication information for indicating the second resources of N ports.

In some embodiments, the port indication information is related to one or more of the following configurations:
a port number indication of the M ports configured in the first resource configuration;
(N1, N2) information of the first resources of M ports configured in the CSI report configuration; and
(N1′, N2′) information of the second resources of N ports configured in the CSI report configuration.

In some embodiments, the port indication information is used to indicate one or more of X types of N-port antenna configurations; where, X is an integer greater than or equal to 1.

In some embodiments, the port indication information indicates X types of N-port antenna configurations; where, X is an integer greater than or equal to 1.

In some embodiments, the port indication information indicates one of X types of N-port antenna configurations via log (X) bits; where, X is an integer greater than or equal to 1.

In some embodiments, the port indication information indicates Y types of X types of N-port antenna configurations via log (C_{Y}^{X}) bits; where, Y≤X, X is an integer greater than or equal to 1.

In some embodiments, the port indication information is indicated via RRC signaling, or the port indication information is indicated in a system-predefined method.

In some embodiments, the port indication information includes: a correspondence between the second resources of N ports and the first resources of M ports.

In some embodiments, the second resources of N ports is a part of the first resources of M ports.

In some embodiments, the transmitting unit 2301 transmits the second resource configuration via one of the following:
RRC signaling;
MAC CE signaling; and
DCI indication information.

In some embodiments, as shown in FIG. 23, the apparatus 2300 further comprises:
a first determining unit 2302 configured to determine time-frequency resource information of the second resources of N ports according to the first resource configuration, the second resource configuration and the CSI report configuration.

In some embodiments, as shown in FIG. 23, the apparatus 2300 further comprises:
a second determining unit 2303 configured to determine time-frequency resource information of the second resources of N ports corresponding to Y types of N-port antenna configurations according to the first resource configuration, the second resource configuration and the CSI report configuration, where, Y≤X, X is an integer greater than or equal to 1.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

It's worth noting that the above only describes components or modules related to the present disclosure, but the present disclosure is not limited to this. The apparatus 2300 for configuring channel state information may further comprise other components or modules. For detailed contents of these components or modules, relevant technologies may be referred to.

Moreover, for the sake of simplicity, FIG. 23 only exemplarily shows a connection relationship or signal direction between components or modules, however persons skilled in the art should know that various relevant technologies such as bus connection may be used. The above components or modules may be realized by a hardware facility such as a processor, a memory, a transmitter, a receiver, etc. The embodiments of the present disclosure have no limitation to this.

Through the embodiments of the present disclosure, when a network device adjusts an antenna configuration, by adding indication restrictions on some antenna ports/patterns, current CSI report is capable of more dynamically matching an actually deployed antenna adjustment. Thereby, a terminal equipment is capable of performing CSI measurement efficiently and accurately, so as to provide accurate channel information for the scheduling of the network device.

### Embodiments of a Fifth Aspect

Embodiments of the present disclosure further provide a communication system, FIG. 1 may be referred to, the contents same as the embodiments of the first to fourth aspects are not repeated.

In some embodiments, a communication system 100 at least may comprise:
a network device 101 configured to transmit a first resource configuration and/or a second resource configuration and/or a CSI report configuration, and
a terminal equipment 102 configured to receive the first resource configuration and/or the second resource configuration and/or the CSI report configuration.

In the above embodiments, the first resource configuration is at least used to configure first resources of M ports; the first resource configuration and/or the second resource configuration and/or the CSI report configuration is/are used to configure second resources of N ports; N being less than M.

Embodiments of the present disclosure further provide a network device, for example may be a base station, but the present disclosure is not limited to this, it may also be other network device.

FIG. 24 is a composition schematic diagram of a network device in the embodiments of the present disclosure. As shown in FIG. 24, the network device 2400 may comprise: a processor 2410 (such as a central processing unit (CPU)) and a memory 2420; the memory 2420 is coupled to the processor 2410. The memory 2420 may store various data; moreover, also stores a program 2430 for information processing, and executes the program 2430 under the control of the processor 2410.

For example, the processor 2410 can be configured to execute a program to implement the method as described in the embodiments of the second aspect.

In addition, as shown in FIG. 24, the network device 2400 may further include: a transceiver 2440 and an antenna 2450, etc.; wherein the functions of said components are similar to relevant arts, which are not repeated here. It's worth noting that the network device 2400 does not have to include all the components shown in FIG. 24. Moreover, the network device 2400 may also include components not shown in FIG. 24, relevant arts can be referred to.

Embodiments of the present disclosure further provide a terminal equipment, but the present disclosure is not limited to this, it may also be other device.

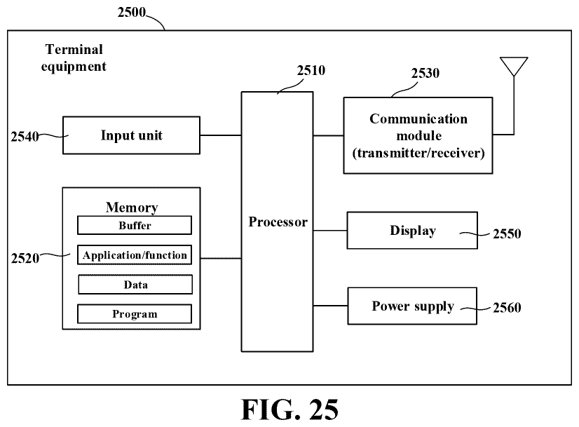

FIG. 25 is a schematic diagram of a terminal equipment in the embodiments of the present disclosure. As shown in FIG. 25, the terminal equipment 2500 may comprise a processor 2510 and a memory 2520; the memory 2520 stores data and programs, and is coupled to the processor 2510. It's worth noting that this figure is exemplary; other types of structures can also be used to supplement or replace this structure, so as to realize a telecommunication function or other functions.

For example, the processor 2510 may be configured to execute a program to implement the method as described in the embodiments of the first aspect.

As shown in FIG. 25, the terminal equipment 2500 may further comprise: a communication module 2530, an input unit 2540, a display 2550 and a power supply 2560. The functions of said components are similar to related arts, which are not repeated here. It's worth noting that the terminal equipment 2500 does not have to include all the components shown in FIG. 25, said components are not indispensable. Moreover, the terminal equipment 2500 may further include components not shown in FIG. 25, related arts may be referred to.

Embodiments of the present disclosure further provide a computer program, wherein when a terminal equipment executes the program, the program enables the terminal equipment to execute the method described in the embodiments of the first aspect.

Embodiments of the present disclosure further provide a storage medium in which a computer program is stored, wherein the computer program enables a terminal equipment to execute the method described in the embodiments of the first aspect.

Embodiments of the present disclosure further provide a computer program, wherein when a network device executes the program, the program enables the network device to execute the method described in the embodiments of the second aspect.

Embodiments of the present disclosure further provide a storage medium in which a computer program is stored, wherein the computer program enables a network device to execute the method described in the embodiments of the second aspect.

The apparatus and method in the present disclosure may be realized by hardware, or may be realized by combining hardware with software. The present disclosure relates to such a computer readable program, when the program is executed by a logic component, the computer readable program enables the logic component to realize the device described in the above text or a constituent component, or enables the logic component to realize various methods or steps described in the above text. The present disclosure further relates to a storage medium storing the program, such as a hard disk, a magnetic disk, an optical disk, a DVD, a flash memory and the like.

By combining with the method/device described in the embodiments of the present disclosure, it may be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings may further be implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art may make various variations and modifications to the present disclosure according to the spirit and principle of the present disclosure, these variations and modifications are also within the scope of the present disclosure.

As for the implementations including the above embodiments, the following supplements are further disclosed:
1. A method for configuring channel state information, wherein the method includes:
a terminal equipment receives a first resource configuration and/or a second resource configuration and/or a CSI report configuration,
the first resource configuration being at least used to configure first resources of M ports,
the first resource configuration and/or the second resource configuration and/or the CSI report configuration being used to configure second resources of N ports,
N being less than M.
2. The method according to Supplement 1, wherein the first resource configuration includes:
port number indication information of the M ports; and/or
resource mapping information for determining time-domain resources and/or frequency-domain resources and/or spatial-domain resources of the M ports.
3. The method according to Supplement 1, wherein the CSI report configuration includes:
(N1, N2) information of the first resources of M ports; and/or,
(N1′, N2′) information of the second resources of N ports.
4. The method according to any one of Supplements 1-3, wherein the second resource configuration includes:
port indication information for indicating the second resources of N ports.
5. The method according to Supplement 4, wherein the port indication information is related to one or more of the following configurations:
a port number indication of the M ports configured in the first resource configuration;
(N1, N2) information of the first resources of M ports configured in the CSI report configuration; and
(N1′, N2′) information of the second resources of N ports configured in the CSI report configuration.
6. The method according to Supplement 4 or 5, wherein,
the port indication information indicates one or more of X types of N-port antenna configurations; where, X is an integer greater than or equal to 1.
7. The method according to Supplement 4 or 5, wherein,
the port indication information indicates X types of N-port antenna configurations; where, X is an integer greater than or equal to 1.
8. The method according to Supplement 4 or 5, wherein,
the port indication information indicates one of X types of N-port antenna configurations via log (X) bits; where, X is an integer greater than or equal to 1.
9. The method according to Supplement 4 or 5, wherein,
the port indication information indicates Y types of X types of N-port antenna configurations via log (C_{Y}^{X}) bits; where, Y≤X, X is an integer greater than or equal to 1.
10. The method according to any one of Supplements 4-9, wherein,
the port indication information is indicated via RRC signaling, or,
the port indication information is indicated in a system-predefined method.
11. The method according to any one of Supplements 4-10, wherein the port indication information includes:
a correspondence between the second resources of N ports and the first resources of M ports.
12. The method according to Supplement 11, wherein,
the second resources of N ports is a part of the first resources of M ports.
13. The method according to any one of the preceding Supplements, wherein the terminal equipment receives the second resource configuration via one of the following:
RRC signaling;
MAC CE signaling; and
DCI indication information.
14. The method according to any one of the preceding Supplements, wherein the method further includes:
the terminal equipment determines time-frequency resource information of the second resources of N ports according to the first resource configuration, the second resource configuration and the CSI report configuration.
15. The method according to any one of the preceding Supplements, wherein the method further includes:
the terminal equipment determines time-frequency resource information of the second resources of N ports corresponding to Y types of N-port antenna configurations according to the first resource configuration, the second resource configuration and the CSI report configuration, where, Y≤X, X is an integer greater than or equal to 1.
16. The method according to any one of the preceding Supplements, wherein the method further includes:
the terminal equipment calculates and reports CSI information of the first resources of M ports and/or the second resources of N ports.
17. The method according to any one of the preceding Supplements, wherein the method further includes:
the terminal equipment calculates CSI information of a set of the second resources of N ports corresponding to X types of N-port antenna configurations, and reports the second resources of N ports corresponding to one of the X types of N-port antenna configurations; where, X is an integer greater than or equal to 1.
18. The method according to Supplement 17, wherein,
if X=1, the terminal equipment does not report the second resources of N ports recommended to be reported.
19. The method according to any one of Supplements 1 to 16, wherein the method further includes:
the terminal equipment calculates CSI information of a set of the second resources of N ports corresponding to Y types of N-port antenna configurations, and reports the second resources of N ports corresponding to one of the Y types of N-port antenna configurations; where, Y≤X, X is an integer greater than or equal to 1.
20. The method according to Supplement 19, wherein,
if Y=1, the terminal equipment does not report the second resources of N ports recommended to be reported.
21. The method according to Supplement 17, wherein the method further includes:
the terminal equipment adds log(X) bits into CSI Part I to report the second resources of N ports corresponding to one of the X types of N-port antenna configurations.
22. The method according to Supplement 19, wherein the method further includes:
the terminal equipment adds log(Y) bits into CSI Part I to report the second resources of N ports corresponding to one of the Y types of N-port antenna configurations.
23. The method according to any one of the preceding Supplements, wherein the method further includes:
the terminal equipment calculates and reports CSI information of a set of the second resources of N ports corresponding to X types of N-port antenna configurations; where, X is an integer greater than or equal to 1.
24. The method according to any one of the preceding Supplements, wherein the method further includes:
the terminal equipment calculates and reports CSI information of a set of the second resources of N ports corresponding to Y types of N-port antenna configurations; where, Y≤X, X is an integer greater than or equal to 1.
25. The method according to any one of the preceding Supplements, wherein the method further includes:
the terminal equipment calculates and reports CSI information of a set of the second resources of N ports corresponding to R types of N-port antenna configurations; where, R≤Y, Y≤X, X is an integer greater than or equal to 1.
1a. A method for configuring channel state information, wherein the method includes:
a network device transmits a first resource configuration and/or a second resource configuration and/or a CSI report configuration,
the first resource configuration being at least used to configure first resources of M ports,
the first resource configuration and/or the second resource configuration and/or the CSI report configuration being used to configure second resources of N ports,
N being less than M.
2a. The method according to Supplement 1a, wherein the first resource configuration includes:
port number indication information of the M ports; and/or
resource mapping information for determining time-domain resources and/or frequency-domain resources and/or spatial-domain resources of the M ports.
3a. The method according to Supplement 1a, wherein the CSI report configuration includes:
(N1, N2) information of the first resources of M ports; and/or,
(N1′, N2′) information of the second resources of N ports.
4a. The method according to any one of Supplements 1a-3a, wherein the second resource configuration includes:
port indication information for indicating the second resources of N ports.
5a. The method according to Supplement 4a, wherein the port indication information is related to one or more of the following configurations:
a port number indication of the M ports configured in the first resource configuration;
(N1, N2) information of the first resources of M ports configured in the CSI report configuration; and
(N1′, N2′) information of the second resources of N ports configured in the CSI report configuration.
6a. The method according to Supplement 4a or 5a, wherein
the port indication information indicates one or more of X types of N-port antenna configurations; where, X is an integer greater than or equal to 1.
7a. The method according to Supplement 4a or 5a, wherein
the port indication information indicates X types of N-port antenna configurations; where, X is an integer greater than or equal to 1.
8a. The method according to Supplement 4a or 5a, wherein
the port indication information indicates one of X types of N-port antenna configurations via log (X) bits; where, X is an integer greater than or equal to 1.
9a. The method according to Supplement 4a or 5a, wherein
the port indication information indicates Y types of X types of N-port antenna configurations via log (C_{Y}^{X}) bits; where, Y≤X, X is an integer greater than or equal to 1.
10a. The method according to any one of Supplements 4a to 9a, wherein
the port indication information is indicated via RRC signaling, or,
the port indication information is indicated in a system-predefined method.
11a. The method according to any one of Supplements 4a-10a, wherein the port indication information includes:
a correspondence between the second resources of N ports and the first resources of M ports.
12a. The method according to Supplement 11a, wherein
the second resources of N ports is a part of the first resources of M ports.
13a. The method according to any one of the preceding Supplements, wherein the network device transmits the second resource configuration via one of the following:
RRC signaling;
MAC CE signaling; and
DCI indication information.
14a. The method according to any one of the preceding Supplements, wherein the method further includes:
the network device determines time-frequency resource information of the second resources of N ports according to the first resource configuration, the second resource configuration and the CSI report configuration.
15a. The method according to any one of the preceding Supplements, wherein the method further includes:
the network device determines time-frequency resource information of the second resources of N ports corresponding to Y types of N-port antenna configurations according to the first resource configuration, the second resource configuration and the CSI report configuration, where, Y≤X, X is an integer greater than or equal to 1.
26. A terminal equipment, comprising a memory and a processor, the memory storing a computer program, and the processor being configured to execute the computer program to implement the method according to any one of Supplements 1 to 25.
27. A network device, comprising a memory and a processor, the memory storing a computer program, and the processor being configured to execute the method according to any one of the supplements 1a to 15a.
28. A communication system, comprising the terminal equipment according to Supplement 26 and the network device according to Supplement 27.

1. An apparatus for configuring channel state information, configured in a terminal equipment, the apparatus comprising:
a receiver configured to receive a first resource configuration and/or a second resource configuration and/or a CSI report configuration,
the first resource configuration being at least used to configure first resources of M ports,
the first resource configuration and/or the second resource configuration and/or the CSI report configuration being used to configure second resources of N ports,
N being less than M.

2. The apparatus according to claim 1, wherein the first resource configuration includes:
port number indication information of the M ports; and/or
resource mapping information for determining time-domain resources and/or frequency-domain resources and/or spatial-domain resources of the M ports.

3. The apparatus according to claim 1, wherein the CSI report configuration includes:
(N1, N2) information of the first resources of M ports; and/or,
(N1′, N2′) information of the second resources of N ports.

4. The apparatus according to claim 1, wherein the second resource configuration includes:
port indication information for indicating the second resources of N ports.

5. The apparatus according to claim 4, wherein the port indication information is related to one or more of the following configurations:
a port number indication of the M ports configured in the first resource configuration;
(N1, N2) information of the first resources of M ports configured in the CSI report configuration; and
(N1′, N2′) information of the second resources of N ports configured in the CSI report configuration.

6. The apparatus according to claim 4, wherein,
the port indication information indicates one or more of X types of N-port antenna configurations; where, X is an integer greater than or equal to 1.

7. The apparatus according to claim 4, wherein,
the port indication information indicates one of X types of N-port antenna configurations via log (X) bits; where, X is an integer greater than or equal to 1.

8. The apparatus according to claim 4, wherein,
the port indication information is indicated via RRC signaling, or,
the port indication information is indicated in a system-predefined method.

9. The apparatus according to claim 4, wherein the port indication information includes:
a correspondence between the second resources of N ports and the first resources of M ports.

10. The apparatus according to claim 9, wherein,
the second resources of N ports is a part of the first resources of M ports.

11. The apparatus according to claim 1, wherein the receiver receives the second resource configuration via one of the following:
RRC signaling;
MAC CE signaling; and
DCI indication information.

12. The apparatus according to claim 1, the apparatus further comprising:
first determining processor circuitry configured to determine time-frequency resource information of the second resources of N ports according to the first resource configuration, the second resource configuration and the CSI report configuration.

13. The apparatus according to claim 1, the apparatus further comprising:
first processor circuitry configured to calculate and report CSI information of the first resources of M ports and/or the second resources of N ports.

14. The apparatus according to claim 1, the apparatus further comprising:
second processor circuitry configured to calculate CSI information of a set of the second resources of N ports corresponding to X types of N-port antenna configurations, and report the second resources of N ports corresponding to one of the X types of N-port antenna configurations; where, X is an integer greater than or equal to 1.

15. The apparatus according to claim 14, wherein,
if X=1, the terminal equipment does not report the second resources of N ports recommended to be reported.

16. The apparatus according to claim 14, the apparatus further comprising:
third processor circuitry configured to add log(X) bits into CSI Part I to report the second resources of N ports corresponding to one of the X types of N-port antenna configurations.

17. The apparatus according to claim 1, the apparatus further comprising:
fourth processor circuitry configured to calculate and report CSI information of a set of the second resources of N ports corresponding to X types of N-port antenna configurations; where, X is an integer greater than or equal to 1.

18. An apparatus for configuring channel state information, configured in a network device, the apparatus comprising:
a transmitter configured to transmit a first resource configuration and/or a second resource configuration and/or a CSI report configuration,
the first resource configuration being at least used to configure first resources of M ports,
the first resource configuration and/or the second resource configuration and/or the CSI report configuration being used to configure second resources of N ports,
N being less than M.

19. The apparatus according to claim 18, wherein the second resource configuration includes:
port indication information for indicating the second resources of N ports.

20. The apparatus according to claim 19, wherein,
the port indication information indicates one or more of X types of N-port antenna configurations; where, X is an integer greater than or equal to 1.
